(19) United States
(12) Patent Application Publication
(10) Pub. No.: US 2024/0368365 A1
(43) Pub. Date: Nov. 7, 2024

(54) FIRM SILICONE RUBBER FOAM THERMAL INSULATION

(71) Applicant: 3M INNOVATIVE PROPERTIES COMPANY, St. Paul, MN (US)

(72) Inventors: Pierre Reinhard Bieber, Korschenbroich (DE); Roman Konietzny, Schwalmtal (DE); Tom Gaide, Koeln (DE); Michael Kempf, Neuss (DE); Craig W. Lindsay, Arden Hills, MN (US); Thomas Apeldorn, Moenchengladbach (DE); Simon Plugge, Duesseldorf (DE); Jeffrey P. Kalish, Woodbury, MN (US); Margaret M. Vogel-Martin, Forest Lake, MN (US); Kazuhiko Mizuno, Tokyo (JP); Bernd Dippel, Koenigswinter (DE)

(21) Appl. No.: 18/687,345

(22) PCT Filed: Sep. 8, 2022
(86) PCT No.: PCT/IB2022/058435

§ 371 Date: Feb. 28, 2024

Related U.S. Application Data
(60) Provisional application No. 63/241,557, filed on Sep. 8, 2021.

(51) Int. Cl. C08J 9/00; C08G 77/12; C08J 9/34; C08K 3/22; C08K 7/14; C08K 9/04; C08K 13/06; H01M 10/653; H01M 50/293; H01M 50/383

(52) U.S. Cl. CPC C08J 9/0095; C08G 77/12; C08J 9/34; C08K 13/06; H01M 10/653; H01M 50/293; H01M 50/383; C08J 2383/05; C08K 2003/2224; C08K 2003/2227; C08K 2003/2241; C08K 7/14; C08K 9/04; C08K 2201/005; C08K 2201/014

(57) ABSTRACT

A thermal insulation/protection barrier that provides thermal insulation and protection to battery cells of a battery assembly. The barrier includes a cured silicone rubber foam layer comprising a plurality of firming particles disposed within the silicone rubber foam layer in an amount sufficient to impart additional firmness to the silicone rubber foam layer so that it takes a greater compressive force to compress the foam layer to a desired compression value, compared to the same silicone rubber foam layer without the firming particles.

### TECHNICAL FIELD

The present disclosure relates generally to the field of silicone rubber foams, more specifically to the field of thermally insulative silicone rubber foams (e.g., in sheet form) that have been made firmer so as to exhibit improved protective properties. The present disclosure also relates to a method of manufacturing such silicone rubber foam and to their use for industrial applications, in particular for electric battery thermal management applications (e.g., in the automotive electric vehicle industry).

### BACKGROUND

Automotive electrification is currently one of the biggest trends in the automotive industry. With electric vehicles, the source of electric energy is supplied by electric battery cells in the form of electric battery assemblies (e.g., modules, packs, etc.). In such assemblies, the battery cells are typically disposed adjacent to each other and separated by a gap. Electric-vehicle batteries are used to power the propulsion system of battery electric vehicles (BEVs) and hybrid electric vehicles (HEVs). These batteries, which are typically lithium ion batteries, are designed with a high ampere hour capacity. The trend in the development of electric vehicle batteries goes to higher energy density in the battery (kWh/kg) to allow the covering of longer distances and to reducing charging times of the battery.

Due to the high energy density of electric vehicle batteries and the high energy flow during charging or discharging of the battery, there is a risk of creation of hot spots and thermal runaway events where the heat generated by a decomposing or otherwise damaged battery cell propagates very rapidly to neighboring cells. Such hot spots and thermal runaway events can also cause the swelling of the affected battery cells, which reduces the distance between the affected battery cells and the adjacent battery cells. This chain reaction might lead to an explosion or a fire spreading throughout the whole electric vehicle.

In that context, the use of thermal management solutions has rapidly emerged as one way the mitigate the temperature rise in battery assemblies. One partial solution is disclosed in US-A1-2007/0259258 (Buck) which describes the use of heat absorbing material to absorb the heat generated by the battery cells of a battery pack assembly and transfer heat out from the case of the assembly thereby maintaining a lower temperature inside each battery pack and the overall battery assembly. Another partial solution is described in US-A1-2019393574 (Goeb et al.) which discloses the use of thermally conductive gap filler compositions comprising thermally conductive filler material for cooling battery assemblies.

### SUMMARY

In an effort to delay or prevent such thermal runaway events and thereby protect nearby structures (e.g., remaining battery cells, vehicle structures, building structures, etc.) and personnel, a thermal insulation/protection barrier has been developed for use within a battery assembly (e.g., in the gap between adjacent battery cells). The inventive barrier is able to withstand the very high temperatures associated with decomposing or otherwise damaged battery cells, which cause battery hot spots and thermal runaway events. When used between adjacent battery cells, the inventive barrier can significantly slow down and even stop a thermal runaway event, because of its resistance to compression, which thereby helps to maintain a desired protective distance or gap between affected and adjacent battery cells. The desired protective distance or gap (i.e., gap size) between adjacent battery cells is that gap size that maintains a thickness of barrier material that sufficiently inhibits the transfer of heat between adjacent battery cells to slow down a thermal runaway event for a desired period of time (e.g., enough time for nearby personnel to escape harm, nearby structures to avoid being damaged, etc.) or to prevent the thermal runaway event. A thermal runaway event is considered prevented, if damage is contained within the battery assembly housing the battery cells and/or at least some, most (greater than 50%) or all of the remaining battery cells in the battery assembly remain usable. The remaining battery cell(s) are those that were not the initial source or starting battery cell(s) of, but for the inventive barrier, could have caused a thermal runaway event. Preferably, none of the remaining battery cells need replacement. Preferably, only the initial source battery cells are damaged to the point of needing replacement.

According to one aspect, the present disclosure relates to a thermal insulation/protection barrier operatively adapted (i.e., configured, dimensioned and/or designed) for being disposed between, so as to provide thermal insulation and protection to, adjacent battery cells of a battery assembly, with the barrier comprising a cured silicone rubber foam layer. The silicone rubber foam layer comprises a plurality of firming particles disposed within, and preferably uniformly throughout, the silicone rubber foam layer in an amount sufficient to impart additional firmness to the silicone rubber foam layer so that it takes a greater compressive force to compress the foam layer to a desired compression value, compared to the same silicone rubber foam layer without the firming particles.

The compression behavior of these foams is a crucial property in terms of delaying or even preventing a thermal runaway event. If a single battery cell decomposes or is otherwise damaged, it can heat up and expand. This can lead to a significant compression of the thermal insulation/protection barrier, and in particular the silicone rubber foam layer, and to a decreased gap between the damaged cell and its neighbor cells. It has been found that the temperature on the neighboring cells strongly depends on substantially maintaining the size of the gap (i.e., the distance between adjacent cells) under operating conditions. It has been discovered that the desired size of the gap, during such a thermal runaway event, can be significantly maintained or at least the reduction of the gap size significantly minimized as the firmness of the foam is increased. Therefore, the development of firmer foams helps to delay or even prevent thermal runaway events.

In one embodiment, the silicone rubber foam layer is formed from a curable and foamable precursor of the silicone rubber foam comprising at least one organopolysiloxane compound A, at least one organohydrogenpolysiloxane compound B comprising at least two or three hydrogen atoms per molecule, at least one hydroxyl containing compound C, an effective amount of a curing catalyst D (e.g., a platinum-based curing catalyst), and a plurality of firming particles disposed within the silicone rubber foam layer in an amount sufficient to cause the silicone rubber foam layer to exhibit a compression value of no more than about 50% when subjected to a compression force of over 100 kPa.

According to one aspect, the present disclosure relates to a silicone rubber foam layer obtainable by a process comprising providing a substrate; providing a first solid film and applying it onto the substrate; providing a coating tool provided with an upstream side and a downstream side, wherein the coating tool is offset from the substrate to form a gap normal to the surface of the substrate; moving the first solid film relative to the coating tool in a downstream direction; providing a curable and foamable precursor of the silicone rubber foam to the upstream side of the coating tool thereby coating the precursor of the silicone rubber foam through the gap as a layer onto the substrate provided with the first solid film; providing a second solid film and applying it along the upstream side of the coating tool, such that the first solid film and the second solid film are applied simultaneously with the formation of the layer of the precursor of the silicone rubber foam; foaming or allowing the precursor of the silicone rubber foam to foam; curing or allowing the layer of the precursor of the silicone rubber foam to cure thereby forming the silicone rubber foam layer; optionally, exposing the layer of the precursor of the silicone rubber foam to a thermal treatment; and optionally, removing the first solid film and/or the second solid film from the silicone rubber foam layer.

According to another aspect, the present disclosure is directed to a process for manufacturing a silicone rubber foam layer, wherein the process comprises providing a substrate; providing a first solid film and applying it onto the substrate; providing a coating tool provided with an upstream side and a downstream side, wherein the coating tool is offset from the substrate to form a gap normal to the surface of the substrate; moving the first solid film relative to the coating tool in a downstream direction; providing a curable and foamable precursor of the silicone rubber foam to the upstream side of the coating tool thereby coating the precursor of the silicone rubber foam through the gap as a layer onto the substrate provided with the first solid film; providing a second solid film and applying it along the upstream side of the coating tool, such that the first solid film and the second solid film are applied simultaneously with the formation of the layer of the precursor of the silicone rubber foam; foaming or allowing the precursor of the silicone rubber foam to foam; curing or allowing the layer of the precursor of the silicone rubber foam to cure thereby forming the silicone rubber foam layer; optionally, exposing the layer of the precursor of the silicone rubber foam to a thermal treatment; and optionally, removing the first solid film and/or the second solid film from the silicone rubber foam layer.

According to yet another aspect, the present disclosure relates to the use of a silicone rubber foam layer as described above, for industrial applications, in particular for thermal management applications in the automotive industry.

### BRIEF DESCRIPTION OF THE DRAWINGS

FIG. 1 is a schematic representation of one exemplary coating apparatus and a process of manufacturing a silicone rubber foam layer according to one exemplary aspect of the present disclosure.

FIG. 2 is a schematic cross-sectional view of one exemplary coating tool useful in the present disclosure.

FIG. 3 is a scanning electron microscope image of a cross section of an exemplary silicone rubber foam layer according to one aspect of the present disclosure.

FIG. 4 illustrates an exemplary battery module assembly according to one aspect of the present disclosure.

FIG. 5 illustrates an exemplary instrument used in the hot side/cold side test.

FIG. 6 is a plot illustrating the variation of the gap in a HCST with temperature.

FIG. 7 is a plot illustrating

FIG. 8 is a plot illustrating the results of the HCST for Ex 14A.

FIG. 9 is a plot illustrating the results of the HCST for Ex 25.

FIG. 10 is a plot illustrating the results of the HCST for Ex 21.

FIG. 11 shows photographs of the 2 layers of Ex 21 after the HCST (left: hot side, right: cold side.)

FIG. 12 illustrates results from thermogravimetric analysis.

### DETAILED DESCRIPTION

According to one aspect, the present disclosure relates to a thermal insulation/protection barrier comprising a cured silicone rubber foam (preferably a non-syntactic silicone rubber foam) layer and being operatively adapted (i.e., configured, dimensioned and/or designed) for being disposed so as to provide thermal insulation and protection within a battery assembly. More particularly, the thermal insulation/protection barrier is operatively adapted for being disposed between, and thereby provide thermal insulation and protection to, adjacent battery cells in a battery assembly. The silicone rubber foam layer comprises firming materials, such as a plurality of firming particles disposed within, and preferably uniformly throughout, the silicone rubber foam layer in an amount sufficient to impart additional firmness to the silicone rubber foam layer so that it takes a greater compressive force to compress the foam layer to a desired compression value, compared to the same silicone rubber foam layer without the firming particles.

According to a more particular aspect, the present disclosure relates to the silicone rubber foam (preferably a non-syntactic silicone rubber foam) layer being formed from a curable and foamable precursor of the silicone rubber foam comprising at least one organopolysiloxane compound A, at least one organohydrogenpolysiloxane compound B comprising at least two or three hydrogen atoms per molecule, at least one hydroxyl containing compound C, an effective amount of a curing catalyst D (e.g., a platinum-based curing catalyst), and a plurality of firming particles disposed within the silicone rubber foam layer in an amount sufficient to cause the silicone rubber foam layer to exhibit desired compression characteristics.

Exemplary firming filler materials include firming particles made from the following materials: aluminum trihydroxide (ATH), magnesium hydroxide (MDH), calcium carbonates, mineral and other ceramic fibers, titanium dioxide (e.g., pyrogenic titanium dioxide), and any combination or mixtures thereof. These firming particles may be surface treated and have low water uptake. Preferably, the firming particles exhibit other desirable properties such as any one or combination of being a silicone foam precursor viscosity increaser, relatively low cost, endothermic, and fire retardant (e.g., particles such as aluminum trihydroxide (ATH), magnesium hydroxide (MDH), and calcium carbonates). Other desirable particle properties include structural reinforcement of the foam matrix, including after the silicone rubber has undergone a ceramification process (i.e., after the silicone has been exposed to elevated temperatures and for a time to be transformed into a silica-based ceramic).

### Exemplary Barrier Embodiments

1. A thermal insulation/protection barrier operatively adapted for being disposed between adjacent battery cells (for use, e.g., with cylindrical battery cells or one side of prismatic or poach battery cells) of a battery pack or module. The thermal insulation/protection barrier comprises a cured silicone rubber foam (preferably a non-syntactic silicone rubber foam) layer having at least one or opposite major surfaces, and at least one optional solid film, wherein the solid film is disposed on, or otherwise, so as to cover the at least one major surface or both opposite major surfaces of the silicone rubber foam layer (e.g., the foam layer can be sandwiched between a the two portions of a folded solid film or between a first solid film and a second solid film), and the silicone rubber foam layer comprises a plurality of firming particles disposed within the silicone rubber foam layer in an amount sufficient to impart additional firmness to the silicone rubber foam layer so that it takes a greater compressive force to compress the foam layer to a desired compression value, compared to the same silicone rubber foam layer without the firming particles.

2. The thermal insulation/protection barrier according to embodiment 1, wherein the silicone rubber foam layer is formed from a curable and foamable precursor of silicone rubber foam comprising:
at least one organopolysiloxane compound A;
at least one organohydrogenpolysiloxane compound B comprising at least two or three hydrogen atoms per molecule;
at least one hydroxyl containing compound C; and
an effective amount of a curing catalyst D (e.g., a platinum-based curing catalyst).

3. The thermal insulation/protection barrier according to any one of the preceding embodiments, wherein the plurality of firming particles are disposed uniformly throughout said silicone rubber foam layer.

4. The thermal insulation/protection barrier according to any one of the preceding embodiments, wherein the plurality of firming particles are in an amount sufficient to cause the silicone rubber foam layer to exhibit a compression value of no more than about 30%, 35%, 40%, 45%, or 50%, when subjected to a compression force of at least 100 kPa, 150 kPa, 200 kPa, 250 kPa, 300 kPa, 350 kPa, 400 kPa, 450 kPa, or 500 kPa.

5. The thermal insulation/protection barrier according to any one of the preceding embodiments, wherein the plurality of firming particles are in an amount sufficient to cause the silicone rubber foam layer to exhibit a compression value of no more than 50%, when subjected to a compression force of over 100 kPa.

6. The thermal insulation/protection barrier according to any one of the preceding embodiments, wherein the amount of firming particles is in the range of from about 10 weight % up to and including about 60 weight %, or in the range of from about 5 volume % up to and including about 30 volume %.

7. The thermal insulation/protection barrier according to any one of the preceding embodiments, wherein the amount of firming particles is about 40 weight %, or about 20 volume %.

8. The thermal insulation/protection barrier according to any one of the preceding embodiments, wherein the firming particles are any one or combination of the following material particles: aluminum trihydroxide (ATH) particles, magnesium hydroxide (MDH) particles, calcium carbonate particles, titanium oxide particles, and mineral fibers.

9. The thermal insulation/protection barrier according to any one of the preceding embodiments, wherein the firming particles have a size (i.e., major axis dimension) in the range of from at least about 0.5 μm up to and including about 3, 5, or 10 μm.

10. The thermal insulation/protection barrier according to any one of the preceding embodiments, wherein the firming particles have a size (i.e., major axis dimension) of about 2.0 μm.

11. The thermal insulation/protection barrier according to any one of the preceding embodiments, wherein the firming particles include non metallic inorganic fibers (e.g., mineral fibers) have length in the range of from at least about 200 μm up to and including about 1000 μm, or in the range of from at least about 250 μm up to and including about 750 μm. For example, it can be desirable for the fiber length to be about 500 μm. The fibers also have a diameter in the range of from at least about 3.0 μm up to and including about 6.0 μm. For example, it can be desirable for the fiber diameter to be about 4.5 μm.

12. The thermal insulation/protection barrier according to any one of the preceding embodiments, wherein the amount of firming particles is sufficient to cause the silicone rubber foam layer to exhibit a compression value of no more than about 25, 30, 35, 40, 45, 50, 55, or 60% when subjected to a compression force of over 100, 200, 300, 400, 500, 600, 700, 800, 900, 1000, 1100, 1200 kPa.

13. The thermal insulation/protection barrier according to any one of the preceding embodiments, wherein the silicone rubber foam layer exhibits a compression value of no more than about 50% when subjected to a compression force of at least 200 kPa.

14. The thermal insulation/protection barrier according to any one of the preceding embodiments, wherein the silicone rubber foam layer exhibits a compression value of no more than about 50% when subjected to a compression force of over 1200 kPa.

15. The thermal insulation/protection barrier according to any one of the preceding embodiments, wherein the silicone rubber foam layer exhibits a compression value of no more than about 30% when subjected to a compression force of over 200 kPa.

16. The thermal insulation/protection barrier according to any one of the preceding embodiments, wherein the silicone rubber foam layer exhibits a compression value of no more than about 30% when subjected to a compression force of over 400 kPa.

17. The thermal insulation/protection barrier according to any one of the preceding embodiments, wherein the silicone rubber foam layer exhibits a compression value of in the range of from about 30% up to a maximum of about 50%, when subjected to a compression force in the range of from about 200 kPa up to no greater than about 1000 kPa.

18. The thermal insulation/protection barrier according to any one of the preceding embodiments, wherein the silicone rubber foam layer exhibits a compression value of in the range of from about 30% up to a maximum of about 50%, when a compression force in the range of from about 300 kPa up to no greater than about 800 kPa.

19. The thermal insulation/protection barrier according to any one of the preceding embodiments, wherein the firming particles, individually or together, exhibit any one or combination of the properties selected from silicone foam precursor viscosity increaser or thickener, foam matrix reinforcement, being relatively low cost, endothermic, and a fire retardant. Particles made from such materials as aluminum trihydroxide (ATH), magnesium hydroxide (MDH), and calcium carbonates exhibit most or all of these properties. Particles made from relatively short ceramic reinforcing particles (e.g., mineral particles, etc.) can provide structural reinforcement of the foam matrix, including after the silicone rubber has undergone a ceramification process (i.e., after the silicone has been exposed to elevated temperatures and for a time to be transformed into a silica-based ceramic). Particles made from titanium dioxide (e.g., pyrogenic titanium dioxide) can contribute to the thickening or increase in viscosity of the silicone foam precursor. The firming particles can be added to the silicone foam precursor Part A, Part B, both Part A and B, after the Parts A and B have been mixed, or after all of the precursor constituents have been combined.

20. A method of using a thermal insulation/protection barrier according to any one of the preceding embodiments in between adjacent battery cells of a battery assembly.

According to another aspect, the present disclosure relates to process for obtaining a silicone rubber (non-syntactic) foam layer, with the process comprising the steps of: providing a substrate; providing a first solid film and applying it onto the substrate; providing a coating tool provided with an upstream side and a downstream side, wherein the coating tool is offset from the substrate to form a gap (substantially) normal to the surface of the substrate; moving the first solid film relative to the coating tool in a downstream direction; providing a curable and foamable precursor of the silicone rubber foam to the upstream side of the coating tool thereby coating the precursor of the silicone rubber foam through the gap as a layer onto the substrate provided with the first solid film; providing a second solid film and applying it (at least partly) along the upstream side of the coating tool, such that the first solid film and the second solid film are applied (substantially) simultaneously with the formation of the (adjacent) layer of the precursor of the silicone rubber foam; foaming or allowing the precursor of the silicone rubber foam to foam; curing or allowing the layer of the precursor of the silicone rubber foam to cure thereby forming the silicone rubber foam layer; optionally, exposing the layer of the precursor of the silicone rubber foam to a thermal treatment; and optionally, removing the first solid film and/or the second solid film from the silicone rubber foam layer.

In the context of the present disclosure, it has been surprisingly found that a silicone rubber foam layer obtainable by a process as described above is provided with excellent thermal insulation properties, excellent heat resistance and stability even at temperatures up to 600° C. and prolonged exposure to heat, excellent thermal insulation/protection barrier performance (e.g., thermal runaway barrier performance, in the context of a multiple electric battery cell module applications), excellent compressibility and low density characteristics. The described silicone rubber foam layer is further characterized by one or more of the following advantageous benefits: a) excellent cushioning performance towards individual battery cells when used in battery assemblies; b) easy and cost-effective manufacturing method, based on readily available starting materials and minimized manufacturing steps; c) formulation simplicity and versatility; d) ability to efficiently cure without the need for any substantial energy input such as elevated temperature or actinic radiation; c) safe handling of the foam layer due to non-use of material or products having detrimental effects to the human body; f) excellent processability and converting characteristics into various forms, sizes and shapes; g) ability to be produced in relatively low thicknesses; h) ready-to-use foam layer in particular for thermal management applications; and i) ability to adhere to various substrates such as metallic or polymeric surfaces without requiring adhesion-promoting processing steps or compositions.

In one advantageous aspect, the silicone rubber foam layer described herein is further provided with excellent flame resistance characteristics, as well as excellent resistance to surface cracking and surface brittleness even after prolonged exposure to temperatures up to 600° C.

Without wishing to be bound by theory, it is believed that these excellent characteristics and performance attributes are due in particular to the combination of the following technical features: a) the use of a curable and foamable precursor of a silicone rubber foam; b) the use of a coating tool; and c) the specific processing step consisting of providing a second solid film and applying it along the upstream side of the coating tool, such that the first solid film and the second solid film are applied simultaneously with the formation of the layer of the precursor of the silicone rubber foam, in particular before the foaming and curing steps have (substantially) started.

Still without wishing to be bound by theory, it is believed that this combination of technical features and in particular the step of applying the first solid film and the second solid film simultaneously with the formation of the layer of the precursor of the silicone rubber foam directly results in a silicone foamed layer provided with advantageous porous structure and foam morphology which translates into providing the above-detailed beneficial characteristics and performance attributes. More particularly, it is believed that this combination of technical features allows the foaming process to occur in a relatively controlled manner, whereby the gaseous cavities (or foam cells) would be allowed to expand in the direction of the foam layer thickness (i.e. in the direction perpendicular to the plane formed by the foam layer) thereby resulting int gaseous cavities having an oblong shape in the direction of the layer thickness and being homogeneously distributed in the resulting foam layer.

As such, the silicone rubber foam layer of the present disclosure is suitable for use in various industrial applications, in particular for thermal management applications. The silicone rubber foam layer of the present disclosure is particularly suitable for thermal management applications in the automotive industry, in particular as a thermal insulation/protection barrier (e.g., as a thermal runaway barrier between adjacent battery cells in an electric vehicle battery module). The silicone rubber foam layer as described herein has thermal runaway barrier properties suitable for use as a spacer between adjacent battery cells or otherwise within rechargeable electrical energy storage systems, such as battery modules, as well as suitable for use between such storage systems (e.g., adjacent battery modules). Advantageously still, the silicone rubber foam layer of the disclosure may be used in the manufacturing of battery modules, in particular electric-vehicle battery modules and assemblies. In a beneficial aspect, the silicone rubber foam layer as described herein is suitable for manual or automated handling and application, in particular by fast robotic equipment, due in particular to its excellent dimensional stability and handling properties. The described silicone rubber foam layer is also able to meet the most challenging fire regulation norms due its outstanding flammability and heat stability characteristics.

In the context of the present disclosure, the term “adjacent” is meant to designate two structures (e.g., battery cells, battery modules, superimposed films or layers, etc.) which are arranged directly next to each other, i.e. which are abutting each other. The terms top and bottom layers or films, respectively, are used herein to denote the position of a layer or film relative to the surface of the substrate bearing such layer or film in the process of forming the silicone rubber foam layer. The direction into which the substrate is moving is referred to herein as downstream direction. The relative terms upstream and downstream describe the position along the extension of the substrate.

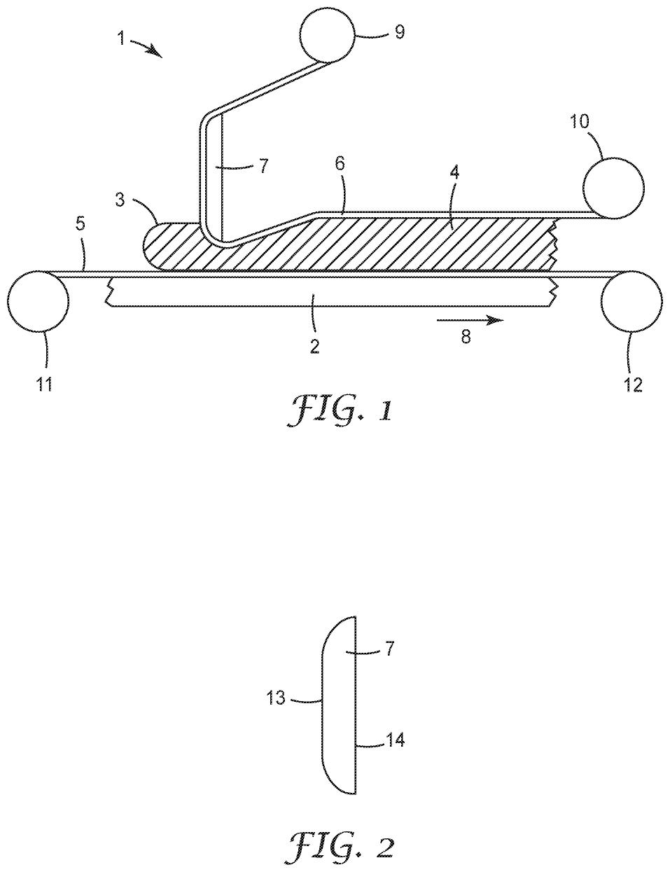

A schematic representation of an exemplary process of manufacturing a silicone rubber foam layer and a coating apparatus suitable for use in the manufacturing process is shown in FIG. 1. The coating apparatus 1 comprises a substrate 2, a coating tool 7 in the form of a coating knife, an unwinding roll 11 and a winding roll 12 for the first solid film 5, an unwinding roll 9 and a winding roll 10 for the second solid film 6. The downstream direction 8 in which the substrate 2 provided with the first solid film 5 is moved relative to the coating tool 7 is represented with an arrow accompanied with the corresponding reference numeral.

In a typical aspect of the disclosure, the curable and foamable precursor of the silicone rubber foam 3 is provided to the upstream side of the coating tool 7 thereby coating the precursor of the silicone rubber foam 3 through the gap as a layer onto the substrate 2 provided with the first solid film 5. In FIG. 1, the curable and foamable precursor of the silicone rubber foam 3 is represented as forming a so-called “rolling bead” at the upstream side of the coating tool 7. The second solid film 6 is applied (at least partly) along the upstream side of the coating tool 7, such that the first solid film 5 and the second solid film 6 are applied simultaneously with the formation of the layer of the precursor of the silicone rubber foam 3. The layer of the precursor of the silicone rubber foam 3 is thereafter allowed to foam and cure resulting into the silicone rubber foam layer 4, which is typically provided with the first solid film 5 on its bottom surface and with the second solid film 6 on its top surface. Optionally, the layer of the precursor of the silicone rubber foam 3 may be exposed to a thermal treatment, typically in an oven (not shown). In a typical aspect, the foaming of the layer of the precursor of the silicone rubber foam 3 results in a silicone rubber foam layer 4 having a thickness higher than the initial layer of the precursor of the silicone rubber foam 3. After processing, the first solid film 5 and/or the second solid film 6 may be removed from the silicone rubber foam layer 4.

Substrates for use herein are not particularly limited. Suitable substrates for use herein may be easily identified by those skilled in the art in the light of the present disclosure.

In a typical aspect of the disclosure, the substrate for use herein is a temporary support used for manufacturing purpose and from which the silicone rubber foam layer is separated and removed subsequent to foaming and curing. The substrate may optionally be provided with a surface treatment adapted to allow for a clean removal of the silicone rubber foam layer from the substrate (through the first solid film). Advantageously, the substrate for use herein and providing a temporary support may be provided in the form of an endless belt. Alternatively, the substrate for use herein may be a stationary (static) temporary support.

In one particular aspect of the disclosure, the silicone rubber foam layer obtained after foaming and curing is separated from the substrate and can be wound up, for example, into a roll.

According to one advantageous aspect of the disclosure, the substrate for use herein comprises a material selected from the group consisting of polymers, metals, ceramics, composites, and any combinations or mixtures thereof.

The silicone rubber foam layer of the disclosure is obtainable by a process using a coating tool provided with an upstream side and a downstream side. The coating tool is offset from the substrate to form a gap normal to the surface of the substrate.

Coating tools for use herein are not particularly limited. Any coating tools commonly known in the art may be used in the context of the present disclosure. Suitable coating tools for use herein may be easily identified by those skilled in the art in the light of the present disclosure.

The coating tools useful in the present disclosure each have an upstream side (or surface) and a downstream side (or surface). In a typical aspect, the coating tool for use herein is further provided with a bottom portion facing the surface of the substrate receiving the precursor of the silicone rubber foam. The gap is measured as the minimum distance between the bottom portion of the coating tool and the exposed surface of the substrate. The gap can be essentially uniform in the transverse direction (i.e. in the direction normal to the downstream direction) or it may vary continuously or discontinuously in the transverse direction, respectively. The gap between the coating tool and the surface of the substrate is typically adjusted to regulate the thickness of the respective coating in conjunction with other parameters including, for example, the speed of the substrate in the downstream direction, the type of the coating tool, the angle with which the coating tool is oriented relative to the normal of the substrate, and the kind of the substrate.

In one advantageous aspect of the disclosure, the gap formed by the coating tool from the substrate (coating tool gap) is in a range from 10 to 3000 micrometers, from 50 to 2500 micrometers, from 50 to 2000 micrometers, from 50 to 1500 micrometers, from 100 to 1500 micrometers, from 100 to 1000 micrometers, from 200 to 1000 micrometers, from 200 to 800 micrometers, or even from 200 to 600 micrometers.

The coating tool for use herein can be arranged substantially normal to the surface of the substrate, or it can be tilted whereby the angle between the substrate surface and the downstream side (or surface) of the coating tool is in arrange from 50° to 130°, or even from 80° to 100°. The coating tool useful in the present disclosure is typically solid and can be rigid or flexible. The coating tool for use herein may take various shapes, forms and sizes depending on the targeted application and expected characteristics of the silicone rubber foam layer.

In an advantageous aspect, the coating tool for use herein comprises a material selected from the group consisting of polymers, metals, ceramics, composites, glass, and any combinations or mixtures thereof. More advantageously, the coating tool for use herein comprises a material selected from the group consisting of metals, in particular aluminum, stainless steel, and any combinations thereof. Flexible coating tools for use herein are typically relatively thin and having in particular a thickness in the downstream direction in a range from 0.1 to 0.75 mm. Rigid coating tools for use herein are usually at least 1 mm, or even at least 3 mm thick.

According to a typical aspect of the disclosure, the coating tool for use herein is selected from the group consisting of coating knifes, coating blades, coating rolls, coating roll blades, and any combinations thereof.

In an advantageous aspect, the coating tool for use herein is selected from the group of coating knifes. It has been indeed found that the use of a coating tool in the form of a coating knife provides a more reproducible coating process and better-quality coating, which translates into a silicone rubber foam layer provided with advantageous properties.

According to another advantageous aspect, the cross-sectional profile of the bottom portion of the coating tool (in particular, a coating knife) in the longitudinal direction is designed so that the precursor layer is formed, and the excess precursor is doctored off. Typically, the cross-sectional profile of the bottom portion which the coating tool exhibits at its transversely extending edge facing the substrate, is essentially planar, curved, concave or convex.

An exemplary coating tool in the form of a coating knife is schematically represented in FIG. 2 in a cross-sectional view, wherein the coating tool 7 is provided with an upstream side 13 and a downstream side 14.

Precursors of the silicone rubber foam for use herein are not particularly limited, as long as they are curable and foamable. Any curable and foamable precursors of a silicone rubber foam commonly known in the art may be formally used in the context of the present disclosure. Suitable curable and foamable precursors of a silicone rubber foam for use herein may be easily identified by those skilled in the art in the light of the present disclosure.

According to an advantageous aspect, the precursor of the silicone rubber foam for use herein is an in-situ foamable composition, meaning that the foaming of the precursor occurs without requiring any additional compound, in particular external compound.

According to another advantageous aspect, the foaming of the precursor of the silicone rubber foam for use herein is performed with a gaseous compound, in particular hydrogen gas.

In a more advantageous aspect, the foaming of the precursor of the silicone rubber foam for use herein is performed by any of gas generation or gas injection.

According to a preferred aspect, the foaming of the precursor of the silicone rubber foam for use herein is performed by gas generation, in particular in-situ gas generation.

In an alternative and less advantageous aspect, the precursor of the silicone rubber foam for use herein further comprises an optional blowing agent.

According to a beneficial aspect, the precursor of the silicone rubber foam for use herein is a two-part composition. Typically, the precursor of the silicone rubber foam may be selected from the group consisting of addition curing type two-part silicone compositions, condensation curing type two-part silicone compositions, and any combinations or mixtures thereof.

In another beneficial aspect of the disclosure, the precursor of the silicone rubber foam for use herein comprises an organopolysiloxane composition.

In a preferred aspect, the precursor of the silicone rubber foam for use herein comprises an addition curing type two-part silicone composition, in particular an addition curing type two-part organopolysiloxane composition.

Suitable addition curing type two-part organopolysiloxane compositions for use herein as the precursor of the silicone rubber foam may be easily identified by those skilled in the art. Exemplary addition curing type two-part organopolysiloxane compositions for use herein are described e.g. in U.S. Pat. No. 4,593,049 (Bauman et al.).

According to a particularly advantageous aspect of the present disclosure, the precursor of the silicone rubber foam for use herein comprises:
a) at least one organopolysiloxane compound A;
b) at least one organohydrogenpolysiloxane compound B comprising at least two, in particular at least three hydrogen atoms per molecule;
c) at least one hydroxyl containing compound C;
d) an effective amount of a curing catalyst D, in particular a platinum-based curing catalyst; and
e) optionally, a foaming agent.

In an exemplary aspect, the at least one organopolysiloxane compound A for use herein has the following formula:

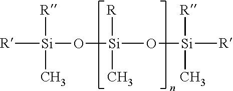

wherein:
R and R″, are independently selected from the group consisting of C₁ to C₃₀ hydrocarbon radicals, and in particular R is an alkyl group chosen from the group consisting of methyl, ethyl, propyl, trifluoropropyl, and phenyl, and optionally R is a methyl group;
R′ is a C₁ to C₂₀ alkenyl radical, and in particular R′ is chosen from the group consisting of vinyl, allyl, hexenyl, decenyl and tetradecenyl, and more in particular R′ is a vinyl radical;
R″ is in particular an alkyl group such as a methyl, ethyl, propyl, trifluoropropyl, phenyl, and in particular R″ is a methyl group; and
n is an integer having a value in a range from 5 to 1000, and in particular from 5 to 100.

In another exemplary aspect, the at least one hydroxyl containing compound C for use herein is selected from the group consisting of alcohols, polyols in particular polyols having 3 to 12 carbon atoms and having an average of at least two hydroxyl groups per molecule, silanols, silanol containing organopolysiloxanes, silanol containing silanes, water, and any combinations or mixtures thereof.

In still another exemplary aspect, the at least one hydroxyl containing compound C for use herein is selected from the group consisting of silanol containing organopolysiloxanes.

According to an advantageous aspect of the present disclosure, the silicone rubber foam layer of the disclosure is obtainable by a process wherein the step of providing a curable and foamable precursor of the silicone rubber foam to the upstream side of the coating tool is performed immediately prior to the step of providing a second solid film and applying it along the upstream side of the coating tool, such that the first solid film and the second solid film are applied (substantially) simultaneously with the formation of the (adjacent) layer of the precursor of the silicone rubber foam.

According to another advantageous aspect of the present disclosure, the step of foaming or allowing the precursor of the silicone rubber foam to foam and the step of curing or allowing the layer of the precursor of the silicone rubber foam to cure thereby forming the silicone rubber foam layer are performed (substantially) simultaneously.

The solid films for use herein as the first and the second solid films are not particularly limited. Any solid films commonly known in the art may be formally used in the context of the present disclosure. Suitable solid films for use herein may be easily identified by those skilled in the art in the light of the present disclosure.

According to one advantageous aspect, the first solid film and/or the second solid film for use in the present disclosure are impermeable films, in particular impermeable flexible films. As used herein, the term “impermeable” is meant to refer to impermeability to liquids and gaseous compounds, in particular to gaseous compounds.

According to another advantageous aspect of the disclosure, the first solid film and/or the second solid film for use herein are selected from the group consisting of polymeric films, metal films, composite films, and any combinations thereof.

In a more advantageous aspect of the disclosure, the first solid film and/or the second solid film for use herein are selected from the group consisting of polymeric films, in particular comprising a polymeric material selected from the group consisting of thermoplastic polymers.

In still a more advantageous aspect of the disclosure, the first solid film and/or the second solid film for use herein are polymeric films, wherein the polymeric material is selected from the group consisting of polyesters, polyethers, polyolefins, polyamides, polybenzimidazoles, polycarbonates, polyether sulfones, polyoxymethylenes, polyetherimides, polystyrenes, polyvinyl chloride, and any mixtures or combinations thereof.

In still a more advantageous aspect of the disclosure, the first solid film and/or the second solid film for use herein are polymeric films comprising a polymeric material selected from the group consisting of polyesters, polyolefins, polyetherimides, and any mixtures or combinations thereof.

In a particularly advantageous aspect, the first solid film and/or the second solid film for use in the present disclosure are polymeric films comprising a polymeric material selected from the group consisting of polyesters, in particular polyethylene terephthalate.

According to an advantageous aspect of the present disclosure, the silicone rubber foam layer of the disclosure is obtainable by a process wherein the first solid film is applied to the bottom surface of the layer of the precursor of the silicone rubber foam, and the second solid film is applied to the top (exposed) surface of the layer of the precursor of the silicone rubber foam.

In a typical aspect of the disclosure, the first solid film and/or the second solid film are contacted directly to the adjacent silicone rubber foam layer.

In another advantageous aspect of the present disclosure, the first major (top) surface and the second (opposite) major (bottom) surface of the silicone rubber foam layer and/or the first solid film and/or the second solid film are (substantially) free of any adhesion-promoting compositions or treatments, in particular free of priming compositions, adhesive compositions and physical surface treatments.

In still another advantageous aspect of the disclosure, no intermediate layers of any sorts are comprised in-between the first major (top) surface or the second (opposite) major (bottom) surface of the silicone rubber foam layer and the first solid film and/or the second solid film.

In a typical aspect of the disclosure, the first and second solid films are smoothly contacted to the corresponding surfaces of the silicone rubber foam layer in a snug fit thereby substantially avoiding (or at least substantially reducing) the inclusion of air between the solid films and the corresponding surfaces of the silicone rubber foam layer.

According to one advantageous aspect, the silicone rubber foam layer of the present disclosure comprises gaseous cavities, in particular gaseous hydrogen cavities, air gaseous cavities, and any mixtures thereof.

According to one advantageous aspect, the silicone rubber foam layer of the disclosure comprises gaseous cavities having a (substantially) oblong shape in the direction of the layer thickness (i.e. in the direction perpendicular to the plane formed by the foam layer).

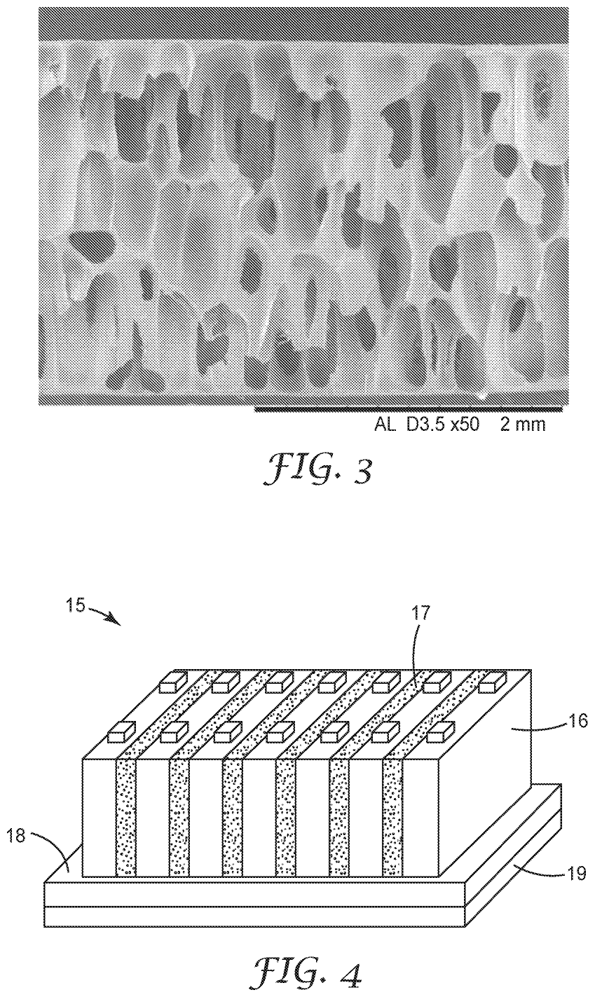

According to a more advantageous aspect, the gaseous cavities that may be present in the silicone rubber foam layer have an elongated oval shape in the direction of the layer thickness. Exemplary gaseous cavities having an elongated oval shape in the direction of the layer thickness are shown in FIG. 3 which is a scanning electron microscope image of a cross section of an exemplary silicone rubber foam layer according to the present disclosure.

Advantageously still, the gaseous cavities for use herein are not surrounded by any ceramic or polymeric shell (other than the surrounding silicone polymer matrix).

In one particular aspect, the gaseous cavities for use herein have a mean average size (of the greatest dimension) no greater than 150 micrometers, no greater than 120 micrometers, no greater than 100 micrometers, no greater than 80 micrometers, no greater than 60 micrometers, no greater than 50 micrometers, no greater than 40 micrometers, no greater than 30 micrometers, or even greater than 20 micrometers (when calculated from SEM micrographs).

In another particular aspect, the gaseous cavities for use herein have a mean average size (of the greatest dimension) in a range from 5 to 3000 micrometers, from 5 to 2000 micrometers, from 10 to 1500 micrometers, from 20 to 1500 micrometers, from 20 to 1000 micrometers, from 20 to 800 micrometers, from 20 to 600 micrometers, from 20 to 500 micrometers, or even from 20 to 400 micrometers (when calculated from SEM micrographs).

According to a typical aspect, the silicone rubber foam layer of the disclosure is (substantially) free of hollow cavities selected from the group consisting of hollow microspheres, glass bubbles, expandable microspheres, in particular hydrocarbon filled expandable microspheres, hollow inorganic particles, expanded inorganic particles, and any combinations or mixtures thereof.

The silicone rubber foam layer of the disclosure may comprise additional (optional) ingredients or additives depending on the targeted application.

In a particular aspect of the disclosure, the silicone rubber foam layer may further comprise an additive which is in particular selected from the group consisting of flame retardants, softeners, hardeners, filler materials, tackifiers, nucleating agents, colorants, pigments, conservatives, rheology modifiers, UV-stabilizers, thixotropic agents, surface additives, flow additives, nanoparticles, antioxidants, reinforcing agents, toughening agents, silica particles, calcium carbonate, glass or synthetic fibers, thermally insulating particles, electrically conducting particles, electrically insulating particles, and any combinations or mixtures thereof. Exemplary filler additives include aluminum trihydroxide (ATH), magnesium hydroxide (MDH), Huntite-Hydromagnesite, talc, clay, Boron based flame retardants, molybdenum compounds, tin compounds, antimony compounds, expandable graphites, gypsum, calcium carbonates and any combination or mixtures thereof. In a particular aspect of the disclosure these fillers may be surface treated and have low water uptake.

In one beneficial aspect, the silicone rubber foam layer further comprises a non-flammable (or non-combusting) filler material. In a more beneficial aspect, the non-flammable filler material for use herein is selected from the group of inorganic fibers, in particular from the group consisting of mineral fibers, mineral wool, silicate fibers, ceramic fibers, glass fibers, carbon fibers, graphite fibers, asbestos fibers, aramide fibers, and any combinations or mixtures.

According to a more advantageous aspect, the non-flammable filler material for use herein is selected from the group consisting of mineral fibers, silicate fibers, ceramic fibers, asbestos fibers, aramide fibers, and any combinations or mixtures.

According to a particularly beneficial aspect, the non-flammable filler material for use herein is selected from the group consisting of mineral fibers. In the context of the present disclosure, it has indeed surprisingly been discovered that a silicone rubber foam which further comprises mineral fibers are provided with excellent thermal resistance and thermal stability characteristics, as well as improved resistance to surface cracking and surface brittleness even after prolonged exposure to temperatures up to 600° C. Without wishing to be bound by theory, it is believed that these beneficial characteristics are due in particular to the excellent compatibility of the mineral fibers (in particular silicate fibers) with the surrounding silicone polymeric matrix, which participates in densifying and mechanically stabilizing the resulting matrix.

In a particular aspect, the non-flammable filler material for use herein is comprised in the silicone rubber foam in an amount ranging from 0.5 to 40 wt. %, from 1 to 30 wt. %, from 1 to 20 wt. %, from 1 to 10 wt. %, from 1 to 8 wt. %, from 2 to 8 wt. %, from 2 to 6 wt. %, or even from 3 to 6 wt. %, based on the overall weight of the precursor composition of the silicone rubber foam.

In another typical aspect, the silicone rubber foam layer of the present disclosure is (substantially) free of thermally conductive fillers.

According to one advantageous aspect of the disclosure, the silicone rubber foam layer has a density no greater than 500 kg/m³, no greater than 450 kg/m³, no greater than 400 kg/m³, no greater than 380 kg/m³, no greater than 350 kg/m³, no greater than 320 kg/m³, no greater than 300 kg/m³, no greater than 280 kg/m³, no greater than 250 kg/m³, no greater than 220 kg/m³, or even no greater than 200 kg/m³, when measured according to the method described in the experimental section.

According to another advantageous aspect of the disclosure, the silicone rubber foam layer has a density in a range from 200 to 500 kg/m³, from 200 to 450 kg/m³, from 200 to 400 kg/m³, from 200 to 380 kg/m³, from 200 to 350 kg/m³, from 200 to 320 kg/m³, from 200 to 300 kg/m³, from 200 to 280 kg/m³, or even from 200 to 250 kg/m³, when measured according to the method described in the experimental section.

According to still another advantageous aspect of the disclosure, the silicone rubber foam layer has a hardness (Shore 00) greater than 10, greater than 15, greater than 20, greater than 25, or even greater than 30.

According to still another advantageous aspect of the disclosure, the silicone rubber foam layer has a hardness (Shore 00) in a range from 10 to 80, from 10 to 70, from 20 to 70, from 25 to 60, from 25 to 55, from 30 to 55, from 30 to 50, from 30 to 45, or even from 30 to 40.

The silicone rubber foam layer can have a compression value of 60% with a compression force of no greater than 250 kPa, no greater than 200 kPa, no greater than 150 kPa, or even no greater than 100 kPa, when measured according to the test method described in the experimental section.

According to still another advantageous aspect of the disclosure, the silicone rubber foam layer has a heat transfer time to 150° C. greater than 20 seconds, greater than 40 seconds, greater than 60 seconds, greater than 80 seconds, greater than 100 seconds, greater than 120 seconds, greater than 140 seconds, greater than 150 seconds, greater than 160 seconds, greater than 170 seconds, or even greater than 180 seconds, when measured according to the test method described in the experimental section.

According to still another advantageous aspect of the disclosure, the silicone rubber foam layer has a heat transfer time to 150° C. in a range from 20 to 600 seconds, from 40 to 600 seconds, from 60 to 500 seconds, from 100 to 500 seconds, from 120 to 400 seconds, from 140 to 300 seconds, from 160 to 200 seconds, or even from 160 to 180 seconds, when measured according to the test method described in the experimental section.

According to yet another advantageous aspect of the disclosure, the silicone rubber foam layer has a thermal conductivity no greater than 1 W/m·K, no greater than 0.8 W/m·K, no greater than 0.6 W/m·K, no greater than 0.5 W/m·K, no greater than 0.4 W/m·K, no greater than 0.3 W/m·K, no greater than 0.2 W/m·K, or even no greater than 0.1 W/m·K, when measured according to the test method described in the experimental section.

According to yet another advantageous aspect of the disclosure, the silicone rubber foam layer has a thermal conductivity in a range from 0.005 to 1 W/m·K, from 0.01 to 1 W/m·K, from 0.02 to 1 W/m·K, or even from 0.02 to 0.8 W/m·K, when measured according to the test method described in the experimental section.

According to yet another advantageous aspect of the disclosure, the silicone rubber foam layer (substantially) undergoes a ceramification process at a temperature no greater than 500° C., no greater than 450° C., no greater than 400° C., no greater than 350° C., no greater than 300° C., or even no greater than 250° C.

According to yet another advantageous aspect of the disclosure, the silicone rubber foam layer (substantially) undergoes a ceramification process at a temperature in a range from 200° C. to 450° C., from 200° C. to 400° C., from 200° C. to 350° C., from 250° C. to 350° C., or even from 250° C. to 300° C.

In the context of the present disclosure, it has indeed surprisingly been discovered that a silicone rubber foam layer which has the ability to undergo a ceramification process, in particular at a relatively low temperature, is provided with excellent thermal resistance and thermal stability characteristics.

According to still another advantageous aspect of the disclosure, the silicone rubber foam layer has a V-0 classification, when measured according to the UL-94 standard flammability test method.

In one advantageous aspect, the silicone rubber foam layer of the present disclosure has a thickness no greater than 6000 micrometers, no greater than 5000 micrometers, no greater than 4000 micrometers, no greater than 3000 micrometers, no greater than 2500 micrometers, no greater than 2000 micrometers, or even no greater than 1500 micrometers.

In another advantageous aspect, the silicone rubber foam layer of the present disclosure has a thickness in a range from 100 to 6000 micrometers, from 200 to 5000 micrometers, from 300 to 5000 micrometers, from 300 to 4500 micrometers, from 300 to 4000 micrometers, from 500 to 4000 micrometers, from 500 to 3000 micrometers, from 500 to 2500 micrometers, from 500 to 2000 micrometers, from 500 to 1500 micrometers, from 800 to 1500 micrometers. or even from 1000 to 1500 micrometers.

According to one particular aspect of the disclosure, the silicone rubber foam layer may be provided with the first solid film and/or the second solid film. In an alternative execution, the silicone rubber foam layer may not be provided with any of the first solid film and/or the second solid film.

As will be apparent to those skilled in the art, the silicone rubber foam layer of the present disclosure may take various forms, shapes and sizes depending on the targeted application. Similarly, the silicone rubber foam layer of the present disclosure may be post-processed or converted as it is customary practice in the field.

According to one exemplary aspect, the silicone rubber foam layer of the disclosure may take the form of a roll which is wound, in particular level-wound, around a core. The silicone rubber foam layer in the wound roll may or may not be provided with the first solid film and/or the second solid film.

According to one exemplary aspect, the silicone rubber foam layer of the disclosure may be cut into smaller pieces of various forms, shapes and sizes.

According to another aspect, the present disclosure is directed to a process for manufacturing a silicone rubber foam layer, wherein the process comprises the steps of: providing a substrate; providing a first solid film and applying it onto the substrate; providing a coating tool provided with an upstream side and a downstream side, wherein the coating tool is offset from the substrate to form a gap normal to the surface of the substrate; moving the first solid film relative to the coating tool in a downstream direction; providing a curable and foamable precursor of the silicone rubber foam to the upstream side of the coating tool thereby coating the precursor of the silicone rubber foam through the gap as a layer onto the substrate provided with the first solid film; providing a second solid film and applying it along the upstream side of the coating tool, such that the first solid film and the second solid film are applied simultaneously with the formation of the layer of the precursor of the silicone rubber foam; foaming or allowing the precursor of the silicone rubber foam to foam; curing or allowing the layer of the precursor of the silicone rubber foam to cure thereby forming the silicone rubber foam layer; optionally, exposing the layer of the precursor of the silicone rubber foam to a thermal treatment; and optionally, removing the first solid film and/or the second solid film from the silicone rubber foam layer.

All the particular and preferred aspects relating to, in particular, the substrate, the first and second solid film, the coating tool, the gap, the curable, foamable precursor of the silicone rubber foam, the optional ingredients, as well as to the various processing steps which were described hereinabove in the context of the silicone rubber foam layer, are fully applicable to the process for manufacturing a silicone rubber foam layer.

According to an advantageous aspect of the process of the disclosure, the first solid film is applied to the bottom surface of the layer of the precursor of the silicone rubber foam, and the second solid film is applied to the top (exposed) surface of the layer of the precursor of the silicone rubber foam.

According to another advantageous aspect of the process of the disclosure, the step of providing a curable and foamable precursor of the silicone rubber foam to the upstream side of the coating tool is performed immediately prior to the step of providing a second solid film and applying it along the upstream side of the coating tool, such that the first solid film and the second solid film are applied (substantially) simultaneously with the formation of the (adjacent) layer of the precursor of the silicone rubber foam.

According to still another advantageous aspect of the process of the disclosure, the step of foaming or allowing the precursor of the silicone rubber foam to foam and the step of curing or allowing the layer of the precursor of the silicone rubber foam to cure thereby forming the silicone rubber foam layer are performed (substantially) simultaneously.

According to still another advantageous aspect of the disclosure, the process is a continuous process whereby the curable and foamable precursor of the silicone rubber foam is continuously provided to the upstream side of the coating tool, in particular from a continuous dispensing device.

According to still another advantageous aspect of the disclosure, the process is a non-continuous process whereby the curable and foamable precursor of the silicone rubber foam is provided to the upstream side of the coating tool discontinuously, in particular from a non-continuous dispensing device.

In still another beneficial aspect of the process, the step of moving the substrate provided with the first solid film relative to the coating tool in a downstream direction is performed at a speed (web speed) in a range from 0.1 to 50 m/min, from 0.1 to 40 m/min, from 0.1 to 30 m/min, from 0.1 to 20 m/min, from 0.1 to 10 m/min, from 0.1 to 8 m/min, from 0.1 to 6 m/min, from 0.1 to 5 m/min, from 0.2 to 5 m/min, from 0.2 to 4 m/min, from 0.3 to 3 m/min, from 0.3 to 2 m/min, from 0.4 to 2 m/min, from 0.4 to 1 m/min, or even from 0.5 to 1 m/min.

In yet another beneficial aspect of the process, the step of providing the curable and foamable precursor of the silicone rubber foam to the upstream side of the coating tool is performed at a throughput in a range from 0.5 to 100 kg/h, from 0.5 to 80 kg/h, from 0.5 to 60 kg/h, from 0.5 to 50 kg/h, from 0.5 to 40 kg/h, 0.5 to 30 kg/h, from 0.5 to 25 kg/h, from 0.5 to 20 kg/h, from 0.5 to 15 kg/h, from 1 to 15 kg/h, from 1.5 to 15 kg/h, from 1.5 to 10 kg/h, from 2 to 10 kg/h, from 2 to 8 kg/h, or even from 2 to 6 kg/h.

In yet another beneficial aspect of the process, the step of providing the curable and foamable precursor of the silicone rubber foam to the upstream side of the coating tool is performed with a coating weight in a range from 10 to 5000 g/m², from 50 to 5000 g/m², from 50 to 4000 g/m², from 50 to 3000 g/m², from 100 to 3000 g/m², from 100 to 2500 g/m², from 150 to 2500 g/m², from 150 to 2000 g/m², from 150 to 1500 g/m², from 150 to 1000 g/m², or even from 200 to 1000 g/m².

In yet another beneficial aspect of the process, the step of foaming or allowing the precursor of the silicone rubber foam to foam is performed at a temperature no greater than 100° C., no greater than 90° C., no greater than 80° C., no greater than 70° C., no greater than 60° C., no greater than 50° C., no greater than 40° C., or even no greater than 30° C.

Advantageoulsy still, the step of foaming or allowing the precursor of the silicone rubber foam to foam is performed at a temperature in a range from 15° C. to 40° C., or even from 20° C. to 30° C.

Advantageoulsy still, the step of foaming or allowing the precursor of the silicone rubber foam to foam is performed with a gaseous compound, in particular hydrogen.

According to another advantageous aspect of the process, the step of foaming or allowing the precursor of the silicone rubber foam to foam is performed by any of gas generation or gas injection, in particular gas generation.

According to still another advantageous aspect of the process, the step of curing or allowing the layer of the precursor of the silicone rubber foam to cure is performed at a temperature no greater than 60° C., no greater than 50° C., no greater than 40° C., or even no greater than 30° C.

Advantageously still, the step of curing or allowing the layer of the precursor of the silicone rubber foam to cure is performed at a temperature in a range from 15° C. to 40° C., or even from 20° C. to 30° C.

Advantageously still, the step of curing or allowing the layer of the precursor of the silicone rubber foam to cure is performed at a temperature in a range from 40° C. to 100° C., from 50° C. to 100° C., from 60° C. to 100° C., from 60° C. to 90° C., or even from 70° C. to 90° C.

In yet another advantageous aspect of the disclosure, the curable precursor of the silicone rubber foam is curable at 23° C. at a curing percentage greater than 90%, greater than 95%, greater than 98%, or even greater than 99%, after a curing time no greater than 72 hours, no greater than 48 hours, or even no greater than 24 hours.

In yet another advantageous aspect of the disclosure, the curable precursor of the silicone rubber foam is curable at 23° C. at a curing percentage greater than 90%, greater than 95%, greater than 98%, or even greater than 99%, after a curing time no greater than 180 minutes, no greater than 210 minutes, no greater than 180 minutes, no greater than 150 minutes, no greater than 120 minutes, no greater than 100 minutes, no greater than 90 minutes, no greater than 80 minutes, no greater than 70 minutes, no greater than 60 minutes, no greater than 50 minutes, no greater than 40 minutes, or even no greater than 30 minutes.

In yet another advantageous aspect of the process of the disclosure, the precursor of the silicone rubber foam is as described above in the context of the silicone rubber foam layer.

According to another beneficial aspect of the process, the precursor of the silicone rubber foam is a two-part composition, in particular an addition curing type two-part silicone composition, more in particular an addition curing type two-part organopolysiloxane composition, and the precursor of the silicone rubber foam is obtained by mixing the two parts of the two-part silicone composition according to a dynamic mixing process.

According to another beneficial aspect of the process, the step of mixing the two parts of the two-part silicone composition is performed with a dynamic mixing device. Advantageously still, the step of mixing the two parts of the two-part silicone composition is performed immediately prior to the step of providing the curable and foamable precursor of the silicone rubber foam to the upstream side of the coating tool.

In yet another advantageous aspect of the process of the disclosure, the first solid film and the second solid film are as described above in the context of the silicone rubber foam layer.

According to an advantageous aspect, the process of the disclosure is (substantially) free of any steps consisting of applying any adhesion-promoting compositions or adhesive compositions to the first major surface and the second (opposite) major surface of the silicone rubber foam layer and/or the first solid film and/or the second solid film.

According to another advantageous aspect, the process of the disclosure is (substantially) free of any steps consisting of (physically) treating the first major surface and the second (opposite) major surface of the silicone rubber foam layer and/or the first solid film and/or the second solid film to enhance their adhesion properties.

According to another aspect, the present disclosure is directed to a thermal insulation/protection barrier article comprising a silicone rubber foam layer as described above.

According to still another aspect, the present disclosure relates to a rechargeable electrical energy storage system, in particular a battery module, comprising a thermal insulation/protection barrier article as described above.

In yet another aspect, the present disclosure is directed to a battery module comprising a plurality of battery cells separated from each other by a gap, and a silicone rubber foam layer as described above positioned in the gap between the battery cells.

FIG. 4 illustrates an exemplary assembled battery module 15 according to one aspect of the present disclosure, which comprises a plurality of battery cells 16 separated from each other by a gap, and a plurality of silicone rubber foam layers 17 positioned in the gap between the battery cells 16. The battery module is further provided with a base plate 19 upon which is positioned a thermally conductive gap filler 18.

Suitable battery modules, battery subunits and methods of manufacturing thereof for use herein are described e.g. in EP-A1-3352290 (Goeb et al.), in particular in FIG. 1 to FIG. 3 and in paragraphs [0016] to [0035], the content of which is herewith fully incorporated by reference.

According to another aspect, the present disclosure is directed to a method of manufacturing a battery module, which comprises the steps of:
a) providing a plurality of battery cells separated from each other by a gap; and
b) positioning a silicone rubber foam layer as described above in the gap between the battery cells.

According to still another aspect, the present disclosure relates to the use of a silicone rubber foam layer as described above for industrial applications, in particular for thermal management applications, more in particular in the automotive industry.

According to yet another aspect, the present disclosure relates to the use of a silicone rubber foam layer as described above as a thermal insulation/protection barrier, in particular a thermal runaway barrier.

In yet another aspect, the present disclosure relates to the use of a silicone rubber foam layer as described above as a thermal insulation/protection barrier, in particular a thermal runaway barrier, in a rechargeable electrical energy storage system, in particular a battery module.

In yet another aspect, the present disclosure relates to the use of a silicone rubber foam layer as described above as a thermal insulation/protection barrier spacer, in particular a thermal runaway barrier spacer, between the plurality of battery cells present in a rechargeable electrical energy storage system, in particular a battery module.

### EXAMPLES

The present disclosure is further illustrated by the following examples. These examples are merely for illustrative purposes only and are not meant to be limiting on the scope of the appended claims.

### Test Methods

### 1) Thermal Stability Test—600° C.

This test was performed in a muffle furnace at 600° C. The test specimens were cut out of the sample sheets and placed in a porcelain crucible. The porcelain crucible was then placed in the furnace at 600° C. for three minutes, then taken out and allowed to cool down before being analyzed via microscopy. The weight loss of the sample after three minutes at 600° C. (in %) was calculated.

### 2) Thermal Insulation Test

This test was performed using a tensile/compression tester from Zwick in compression mode. The compression tester is equipped with two plates (dimensions: 65×80×20mm W×L×H, made of Inconel® steel, the outer faces being thermally insulated): a cold (23° C.) bottom plate equipped with a thermocouple to record temperature and a heated upper plate with a constant temperature of 600° C. At the beginning of the test, a heat shield was placed between the two plates. The sample was placed on the bottom cold plate, then the heat shield is removed. The upper plate was moved to a gap of 1000 micrometers between the two plates and the temperature increase of the cold plate is recorded over time. Specifically, the time when the cold plate reaches 150° C. was recorded in seconds.

### 3) Thermal Conductivity Measurement

The thermal conductivity of the cured compositions is measured using the flash analysis method in a Netzsch Hyperflash LFA 467 (Netzsch, Selb, Germany) according to ASTM E1461/DIN EN821 (2013). Samples of 1 mm thickness are prepared by coating of the curable composition between two PET release liners with a knife coater and curing at room temperature. The samples are then carefully cut to 10 mm×10 mm squares with a knife cutter to fit in the sample holder. Before measurement, samples are coated with a thin layer of graphite (GRAPHIT 33, Kontakt Chemie) on both sides. In a measurement, the temperature of the top side of the sample is measured by an InSb IR detector after irradiation of a pulse of light (Xenon flash lamp, 230 V, 20-30 microsecond duration) to the bottom side. Diffusivity is then calculated from a fit of the thermogram by using the Cowan method. Three measurements are done for each sample at 23° C. For each formulation, three samples are prepared and measured. The thermal conductivity is calculated from the thermal diffusivity, density and specific heat capacity of each sample. The thermal capacity (Cp) is calculated in Joules per gram per Kelvin using the Netzsch-LFA Hyper Flash in combination with a standard sample (Polyceram). The density (d) is determined in grams per cubic centimeter based on the weight and geometric dimensions of the sample. Using these parameters, the thermal conductivity (L) was calculated in Watts per meter·Kelvin according to L=a·d·Cp.

### 4) Flammability Test

The test was performed using the UL-94 standard, the Standard for safety of Flammability of Plastic Materials for Parts in Devices and Appliances testing. The UL-94 standard is a plastics flammability standard released by Underwriters Laboratories of the United States. The standard determines the material's tendency to either extinguish or spread the flame once the specimen has been ignited. The UL-94 standard is harmonized with IEC 60707, 60695-11-10 and 60695-11-20 and ISO 9772 and 9773. The samples size which is a 75 mm×150 mm sheet is exposed to a 2 cm, 50W tirrel burner flame ignition source. The test samples were placed vertically above the flame with the test flame impinging on the bottom of the sample. For each sample, the time to extinguish was measured and V ratings were assigned. V ratings are a measure to extinguish along with the sample not burning to the top clamp or dripping molten material which would ignite a cotton indicator, as shown in Table 1 below.

TABLE 1
UL94 classification (V rating).

| UL 94 classification | V-0 | V-1 | V-2 |
|---|---|---|---|
| Burning stops within | 10 s | 30 s | 30 s |
| Drips of burning material | No | No | Yes |
| allowed (ignites cotton ball) | | | |
| Total burn of sample | No | No | No |

### 5) Compression Test

The compression test was performed using a tensile tester from Zwick in compression mode. The samples used for the Examples had a diameter of 50.8 mm and a thickness >1000 micrometers.

The test was performed at room temperature (typically 23° C.). The upper plate of the compression tester was moved with a speed of 1 mm/min until a maximum force of 2 MPa is reached. Either compression force (in kPa) required to reach a compression value was recorded, or the compression value resulting from a given compression force was recorded. The compression force is plotted against the deformation of the sample.

### 6) Coating Weight

The coating weight of the silicone rubber foam layers was measured by weighing a sample of 100 cm² cut out of the sample layer using a circle cutter. The coating weight was then converted to g/m².

### 7) Thickness

The thickness of the silicone rubber foam layers was measured using a thickness gauge.

### 8) Density

The density (in kg/m³) of the silicone rubber foam layers was calculated by dividing the coating weight of the foam layers (in kg/m²) by their thickness (in m).

### 9) SEM Micrographs

The silicone rubber foam images were obtained from SEM micrographs recorded on a Tabletop Microscope TM3030, available from Hitachi High-Tech Corporation.

### 10) Hot Side/Cold Side Test (HCST)

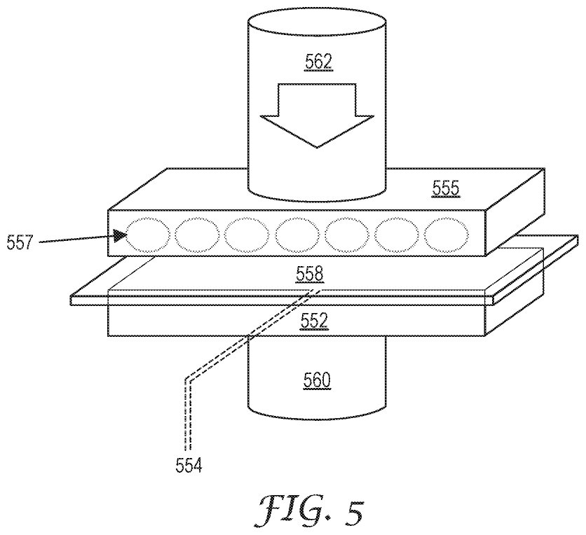

This test was performed using a tensile/compression tester from Zwick in a compression mode. The compression tester is equipped with 2 plates: a cold (RT) bottom plate (552) equipped with a thermocouple (554) to record temperature and a heated upper plate (555) with a constant temperature of 600° C. The upper plate (555) is being heated with elements (557). At the beginning of the test a heat shield (558) is between the 2 plates. The sample is placed on the bottom cold plate, then the heat shield is removed, and the upper plate is moved to the desired gap between the 2 plates (here 1.0 or mm) or to the desired compression force and the temperature of the cold side starts to be recorded. See FIG. 5. Depending on the example, the compression force was 0.1 MPa, 0.5 MPa or 1.0 MPa. The compression force is applied via the cylinder (562) and the bottom plate (552) is being supported by the cylinder (560).

### Raw Materials

In the examples, the following raw materials were used:
DOWSIL 3-8209 and DOWSIL 3-8235 are two-part room temperature curable silicone rubber foam formulations commercially available under the trade designation DOWSIL obtained from the Dow Chemical Company of Midland, MI, United States. The Dowsil 3-8209 used has a Part A density of 1.07 kg/cm³, a Part B density of 1.01 kg/cm³, a Part A viscosity of 15000 mPa·s and a Part B viscosity of 15000 mPa·s.
BLUESIL 3242 is a two-component foam commercially available under the trade designation BLUESIL obtained from Elkem of Olso, Norway.
Hostaphan RN 50/50 is a neat PET solid film obtained from Mitsubishi Polyester Film of Greer, SC. United States.
CoatForce CF30 is a silicate fiber and CoatForce 50 is a mineral fiber both obtained from Rockwool B.V., The Netherlands.
Martinal OL-104 LEO is a fine aluminum trihydroxide (ATH) obtained from Martinswerk GmBH of Bergheim, Germany available under the trade designation Martinal OL-104 LEO.
IMERSEAL 74S is a surface treated calcium carbonate available under the trade designation IMERSEAL obtained from WhitChem of Staffordshire, United Kingdom.
Magnifin H-5 is a fine Magnesium Hydroxide (MDH) with a d50 of 1.8 μm and purchased from Martinswerk Huber Minerals.
Magnifin H-5A is a fine Magnesium Hydroxide (MDH) that has a vinyl surface modification and a d50 of 1.8 μm, and purchased from Martinswerk Huber Minerals.
Aeroxide PF2 is a pyrogenic titanium dioxide with 2% of iron dioxide obtained from Evonik.
AFI PU Foam is a polyurethane foam sheet with a thickness of about 2000 micrometers obtained from Aerofoam Industries of Lake Elsinore, CA, United States and commercially available as a flame-retardant polymeric foam.

### EXAMPLES

### General Hand-Made Preparation Method for the Exemplary Silicone Rubber Foam Layers Containing Fillers (Examples 1 to 5)

The exemplary hand-made silicone rubber foam layers were prepared according to the following procedure:

The identified mineral fibers (refer to Table 1) in weight parts were added to each part A and B of a silicone foam using a speedmixer at a speed of 2500 RPM for 30 seconds, 2 times.

The quantities of materials in weight parts as identified in Table 7 were added to a 200 ml two-part cartridge system from Adchem GmbH with a volumetric mixing ratio of 1:1 (200 mL F System cartridge). The two-part silicone system was mixed with a static mixer (MFH 10-18T) using a dispensing gun at 4 bar air pressure. After releasing 50 g of the mixed silicone in a jar, the mixture was additionally homogenized by hand using a wooden spatula for 10 seconds. This mixture was then coated with a knife coater with a gap thickness of 350 micrometers between two layers of solid film Hostaphan, as represented in FIG. 1. The obtained sheet began to expand, and the reaction was completed by putting the sheet in a forced air oven at 80° C. for 10 minutes. Thickness, coating weight, density, thermal conductivity, and compression testing were conducted, and the results are also contained in Table 1.

TABLE 1
Composition Data and Test Results

| | | Ex. 1 | Ex. 2 | Ex. 3 | Ex. 4 | Ex. 5 |
|---|---|---|---|---|---|---|
| Part A | DOWSIL 3-8209 | 100 | 100 | 100 | 100 | 100 |
| | ATH OL-104 LEO | 56 | 25 | 43 | 56 | 100 |
| Part B | DOWSIL 3-8209 | 100 | 100 | 100 | 100 | 100 |
| | ATH OL-104 LEO | 59 | 0 | 0 | 0 | 0 |
| | IMERSEAL 74S | 0 | 30 | 51 | 67 | 120 |
| Results | Thickness (um) | 1100 | 1800 | 1650 | 2200 | 1800 |
| | Coating Weight | 547 | 533 | 580 | 803 | 887 |
| | (g/m²) | | | | | |
| | Density (kg/m³) | 497 | 296 | 352 | 365 | 492 |
| | Thermal | N.D | 0.05 | N.D | 0.08 | 0.11 |
| | conductivity | | | | | |
| | (W/m · K) | | | | | |
| | Compression | N.D | 20 | 73 | 260 | 513 |
| | force @ 40% | | | | | |
| | compression | | | | | |
| | deformation | | | | | |
| | (kPa) | | | | | |
| | Compression | N.D | 63 | 220 | 667 | 1588 |
| | force @ 60% | | | | | |
| | compression | | | | | |
| | deformation | | | | | |
| | (kPA) | | | | | |

N.D indicates not determined.

### General Hand-Made Preparation Method for the Exemplary Silicone Rubber Foam Layers Containing Fillers (Examples 6 to 8)

The same procedure was followed as described in Examples 1-5 except that another mineral fiber was included (it was pre-mixed with the ATH before the two-part composition was added to the 200 mL cartridge). Also, the obtained sheet began to expand, and the reaction was completed by putting the sheet in a forced air oven at 40° C. for 10 minutes. The mixture was then coated with a knife coater with a gap thickness of 350 micrometers (Ex.6), 400 micrometers (Ex. 7), and 800 micrometers (Ex.8) between two layers of Hostaphan RN 50/50 solid film, as represented in FIG. 1. Thickness, coating weight, density, thermal conductivity, and compression testing were conducted, and the results are contained in Table 2 along with Part A and Part B quantities in weight parts.

TABLE 2
Composition Data and Test Results

| | | Ex. 6 | Ex. 7 | Ex. 8 |
|---|---|---|---|---|
| Part A | DOWSIL 3-8209 | 100 | 100 | 100 |
| | ATH OL-104 LEO | 43 | 56 | 100 |
| | CoatForce 50 | 5 | 5 | 5 |
| Part B | DOWSIL 3-8209 | 100 | 100 | 100 |
| | IMERSEAL 74S | 51 | 67 | 120 |
| Results | Thickness (μm) | 2120 | 2080 | 2300 |
| | Coating Weight (g/m²) | 548 | 660 | 1414 |
| | Density (kg/m³) | 258 | 317 | 615 |
| | Thermal conductivity (W/m · K) | 0.05 | 0.06 | 0.13 |
| | Compression force @ 40% | 102 | 200 | N.D |
| | compression deformation (kPa) | | | |
| | Compression force @ 60% | 191 | 441 | N.D |
| | compression deformation (kPa) | | | |

### General Hand-Made Preparation Method for the Exemplary Silicone Rubber Foam Layers (Examples 1-8) and Comparative Examples CE1 and CE2

The A and B parts were weighted in together with the corresponding filler and firming package and mixed by hand. Afterwards they were mixed in a Speedmixer 2500 rpm for 30 seconds two times.

Silicone foam sheets were prepared according to the following procedure: the silicone precursor part A and B of each example were filled in a 200 mL two-part cartridge system from Adchem with a volumetric mixing ratio of 1:1 (200 mL F System cartridge). In Process 1, the material was kept at room temperature whereas the material in Process 2 was cooled to 7° C. prior mixing. The two-part silicone system is mixed with a static mixer (MFH 10-18T) using a dispensing gun at 6 bar air pressure. After releasing 65 g of the mixed silicone in a jar, the mixture is additionally homogenized by hand using a wooden spatula for 10 seconds. The mixture is then coated with a knife coater between two PET liner with a defined gap. The obtained sheet begins to expand at room temperature already, the reaction is completed in a forced air convection oven at 60° C. for 10 minutes. In Process 1 the obtained sheet was immediately put into the oven whereas in process 2 the material was kept at room temperature for 10 minutes.

### Process Conditions

| | Temperature prior | | |
|---|---|---|---|
| | mixing | Mixing step | Post Curing step |
| Process | Room | Static mixer from | 10 minutes |
| 1 | temperature | 200 mL cartridge + 10 | @60° C. |
| | | seconds hand mix with | |
| | | wooden spatula | |
| Process | 7° C. | Static mixer from | 10 minutes at |
| 2 | | 200 mL cartridge + 10 | room temperature, |
| | | seconds hand mix with | then 10 minutes |
| | | wooden spatula | @60° C. |

### Hot Side Cold Side Test Performance

In the Hot Side/Cold Side Test (HCST), the foam gets heated at one side to 600° C. (hot side) and a pressure is applied, which compresses the foam. The temperature is measured on the other side of the foam. Due to the compression of the foam at a given pressure, the gap between the hot side and the cold side decreases. To investigate the influence of the gap size on the isolation performance of the inventive foam, the foams were prepared with different thicknesses and compression behaviors (Ex 9-15).

HCST Experiments. Table 3 summarizes the foams used for these experiments. The initial gap size of the HCST, the applied pressure in the HCST, the resulting temperature of the cold side after 10 minutes in the HCST the resulting gap sizes and compression values after 10 minutes in the HCST (THCST=600° C.) are summarized in Table. Additionally, compression values at the same pressure at room temperature obtained from the compression test method are given.

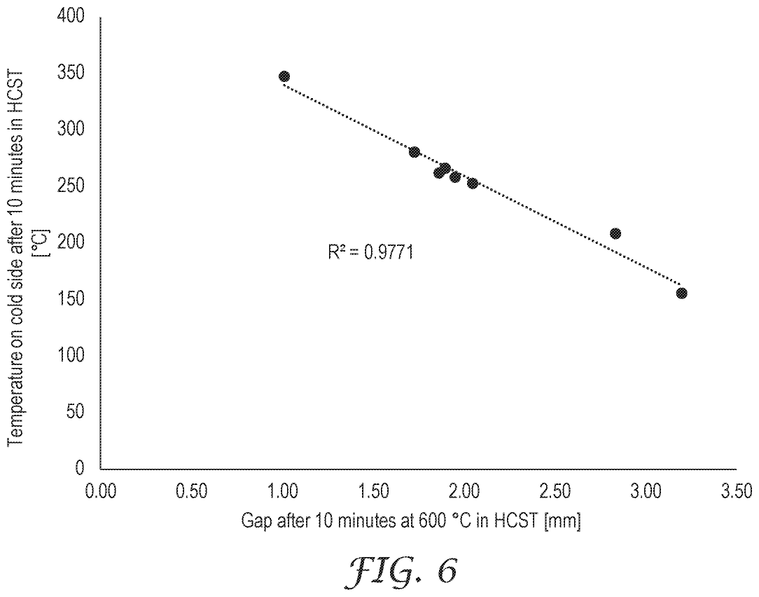

The size of the gap and the temperature on the cold side were investigated after 10 minutes in the HCST with the samples from Table 3. FIG. 6 shows the dependency of the temperature on the cold side after 10 minutes HCST from the gap size after 10 minutes HCST. The correlation between these values is linear for the investigated system and experiment design space meaning that the isolation performance increases with increasing gap retention in the HCST. A higher gap retention can be achieved via increasing the firmness of the foam.

TABLE 3
HCST Experiments

| | Example # | Ex 9 | Ex 10 | Ex 12 | Ex 13 | Ex 14 |
|---|---|---|---|---|---|---|
| Description | Volume % of | 12% ATH | 12% ATH | 9.7% ATH | 9.7% ATH | 11.3% ATH |
| | filler | 1.3% Fiber | 1.3% Fiber | 1.5% Fiber | 1.5% Fiber | 2.8% Fiber |
| | in mixed foam | 9.9% | 9.9% | 9.9% | 9.9% | 12.0% |
| | | CaCO₃ | CaCO₃ | CaCO₃ | CaCO₃ | CaCO₃ |
| A-Part | A-Part Dowsil | 100 | 100 | 100 | 100 | 100 |
| Composition | 3-8209 | | | | | |
| (in weight | ATH | 73 | 73 | 56 | 56 | 71 |
| parts) | OL104LEO | | | | | |
| | CF 50 fibers | 9 | 9 | 10 | 10 | 20 |
| | Weight % | 40.1 | 40.1 | 33.7 | 33.7 | 37.17 |
| | fillers in part | | | | | |
| | A | | | | | |
| | Vol % fillers in | 23.9 | 23.9 | 19.4 | 19.4 | 22.68 |
| | part A | | | | | |
| | Weight % | 5 | 5 | 6.0 | 6.0 | 10.47 |
| | fibers in part | | | | | |
| | A | | | | | |
| | Vol % fibers in | 2.6 | 2.6 | 3.1 | 3.1 | 5.68 |
| | part A | | | | | |
| B-Part | B-Part Dowsil | 100 | 100 | 100 | 100 | 100 |
| Composition | 3-8209 | | | | | |
| (in weight | CaCO₃ | 67 | 67 | 67 | 67 | 85 |
| parts) | Imerseal 74S | | | | | |
| | Weight % | 40.1 | 40.1 | 40.1 | 40.1 | 45.9 |
| | fillers in part | | | | | |
| | B | | | | | |
| | Vol % fillers in | 19.9 | 19.9 | 19.9 | 19.9 | 23.9 |
| | part B | | | | | |
| Process | Process | Process 1 | Process 1 | Process 2 | Process 1 | Process 1 |
| | Gap [μm] | 450 | 900 | 1750 | 1750 | 650 |
| Results | Foam | 2522 | 3303 | 5200 | 6550 | 2410 |
| | Thickness | | | | | |
| | [μm] | | | | | |
| | Coating | 918 | 1437 | 2711 | 2525 | 1136 |
| | weight [g/m²] | | | | | |
| | Density | 0.36 | 0.43 | 0.52 | 0.39 | 0.47 |
| | [g/mL] | | | | | |
| | Pressure at | 194 | 253 | 399 | 187 | 428 |
| | 30% | | | | | |
| | compression | | | | | |
| | [kPa] | | | | | |
| | Pressure at | 261 | 326 | 536 | 250 | 596 |
| | 40% | | | | | |
| | compression | | | | | |
| | [kPa] | | | | | |
| | Pressure at | 379 | 429 | 831 | 364 | 930 |
| | 50% | | | | | |
| | compression | | | | | |
| | [kPa] | | | | | |
| | Pressure at | 654 | 648 | 1798 | 649 | 1965 |
| | 60% | | | | | |
| | compression | | | | | |
| | [kPa] | | | | | |

TABLE 4
Data Overview HCST

| | | | | Temp | | Com- | Com- |
|---|---|---|---|---|---|---|---|
| | | Initial | | Cold | Gap | pression | pression |
| Example | Layers | Gap | Pressure | side | after | 600° C. | RT |
| Ex9 | 3 layers | 7.57 | 1 | 266.3 | 1.90 | 74.9 | 68.0 |
| Ex10 | 2 layers | 6.88 | 1 | 262.1 | 1.86 | 72.9 | 66.1 |
| Ex10 | 1 layer | 3.72 | 1 | 347.5 | 1.01 | 72.8 | n.d. |
| Ex12 | 1 layer | 5.19 | 1 | 258.5 | 1.95 | 62.4 | 54.1 |
| Ex12 | 1 layer | 5.13 | 0.5 | 208.6 | 2.84 | 44.7 | 37.9 |
| Ex13 | 1 layer | 6.32 | 1 | 253.1 | 2.05 | 67.6 | 64.8 |
| Ex14 | 2 layer | 5.69 | 1 | 156.0 | 3.20 | 43.8 | 51.0 |

### Foam Firmness Performance

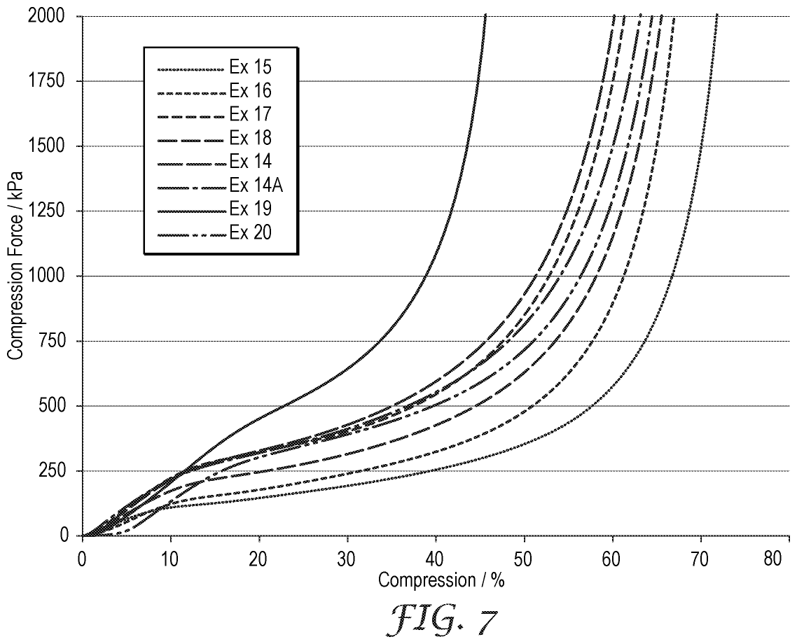

The influence of the different fillers in the foams were evaluated to understand how to increase the firmness of the foams. Table 3 summarizes the tested foams. FIG. 7 shows the compression test results of the foams.

Examples 15-17 show the influence of an increased ATH (from 9.8 vol % to 13.7 vol %) and CaCO3 (from 9.9 vol % to 13.8 vol %) concentration. The firmness of the foam increases with increasing filler concentration. Also, density (from 0.36g/mL to 0.5g/mL) and coating weight (from 980 to 1167g/m2) of the foams increase, while the thickness of the foams decreases with increasing filler load at a given gap size.

Comparison of example 16, 18 and 14 shows the influence of an increased fiber concentration (from 0.7 vol % to 2.8 vol %) at a constant filler level (in weight parts). The firmness of the foam increases with increasing fiber concentration. A compression test was also conducted with two layers of the foam from Ex 14A. The firmness of this construction is slightly lower compared to the single layer construction

Example 19 represents a foam with a very high filler (14.8 vol % ATH and 15 vol % CaCO3) and fiber concentration (2.3 vol %). The resulting foam is extremely firm and has a very high density of 0.75 g/mL. Especially the viscosity of the A part is very high and probably near the upper limit for processability with Process 3.

Example 20 represents a foam with a higher thickness of 6830 μm. Usually, the firmness of the foam decreases with increasing thickness. Although a thicker foam is made in this example, the firmness of the foam is still high.

TABLE 5
Foam Formulations

| | Example # | Ex 15 | Ex 16 | Ex 17 | Ex 18 | Ex 14 | Ex 14A | Ex 19 | Ex 20 |
|---|---|---|---|---|---|---|---|---|---|
| Description | Volume % of | 9.8% | 11.8% | 13.7% | 11.7% | 11.3% | 11.3% | 14.8% | 13.4% |
| | filler | ATH | ATH | ATH | ATH | ATH | ATH | ATH | ATH |
| | in mixed | 0.8% | 0.7% | 0.7% | 1.5% | 2.8% | 2.8% | 2.3% | 2.1% |
| | foam | Fiber | Fiber | Fiber | Fiber | Fiber | Fiber | Fiber | Fiber |
| | | 9.9% | 12% | 13.8% | 12% | 12% | 12% | 15% | 13.8% |
| | | CaCO₃ | CaCO₃ | CaCO₃ | CaCO₃ | CaCO₃ | CaCO₃ | CaCO₃ | CaCO₃ |
| A-Part | A-Part Dowsil | 100 | 100 | 100 | 100 | 100 | 100 | 100 | 100 |
| Composition | 3-8209 | | | | | | | | |
| (in weight | ATH | 56 | 71 | 86 | 71 | 71 | 71 | 101 | 87 |
| parts) | OL104LEO | | | | | | | | |
| | CF 50 fibers | 5 | 5 | 5 | 10 | 20 | 20 | 17.5 | 15 |
| | Weight % | 34.8 | 40.3 | 45.0 | 39.2 | 37.17 | 37.17 | 46.2 | 43.1 |
| | fillers in part | | | | | | | | |
| | A | | | | | | | | |
| | Vol % fillers in | 19.7 | 23.7 | 27.3 | 23.3 | 22.68 | 22.68 | 29.6 | 26.8 |
| | part A | | | | | | | | |
| | Weight % | 3.1 | 2.8 | 2.6 | 5.5 | 10.47 | 10.47 | 8.0 | 7.4 |
| | fibers in part | | | | | | | | |
| | A | | | | | | | | |
| | Vol % fibers in | 1.6 | 1.5 | 1.4 | 2.9 | 5.68 | 5.68 | 4.6 | 4.1 |
| | part A | | | | | | | | |
| B-Part | B-Part Dowsil | 100 | 100 | 100 | 100 | 100 | 100 | 100 | 100 |
| Composition | 3-8209 | | | | | | | | |
| (in weight | CaCO₃ | 67 | 85 | 103 | 85 | 85 | 85 | 116 | 103 |
| parts) | Imerseal 74S | | | | | | | | |
| | Weight % | 40.1 | 45.9 | 50.7 | 45.9 | 45.9 | 45.9 | 53.7 | 50.7 |
| | fillers in part | | | | | | | | |
| | A | | | | | | | | |
| | Vol % fillers in | 19.9 | 23.9 | 27.6 | 23.9 | 23.9 | 23.9 | 30.1 | 27.6 |
| | part A | | | | | | | | |
| Process | Process | Process | Process | Process | Process | Process | Process | Process | Process |
| | | 1 | 1 | 1 | 1 | 1 | 1 | 1 | 1 |
| | Gap [μm] | 600 | 600 | 650 | 550 | 650 | 650 | 650 | 2300 |
| Results | Foam | 2725 | 2520 | 2315 | 2308 | 2410 | 2410 × | 1620 | 6830 |
| | Thickness | | | | | | 2 | | |
| | [μm] | | | | | | | | |
| | Coating | 980 | 1096 | 1167 | 1019 | 1136 | 1136 | 1217 | 3254 |
| | weight | | | | | | | | |
| | [g/m²] | | | | | | | | |
| | Density | 0.36 | 0.44 | 0.50 | 0.44 | 0.47 | 0.47 | 0.75 | 0.48 |
| | [g/mL] | | | | | | | | |
| | Pressure at | 193 | 240 | 403 | 315 | 428 | 412 | 645 | 392 |
| | 30% | | | | | | | | |
| | compression | | | | | | | | |
| | [kPa] | | | | | | | | |
| | Pressure at | 255 | 324 | 546 | 427 | 596 | 554 | 1088 | 505 |
| | 40% | | | | | | | | |
| | compression | | | | | | | | |
| | [kPa] | | | | | | | | |
| | Pressure at | 354 | 479 | 850 | 630 | 930 | 814 | n.d | 718 |
| | 50% | | | | | | | | |
| | compression | | | | | | | | |
| | [kPa] | | | | | | | | |

### Compression Curves

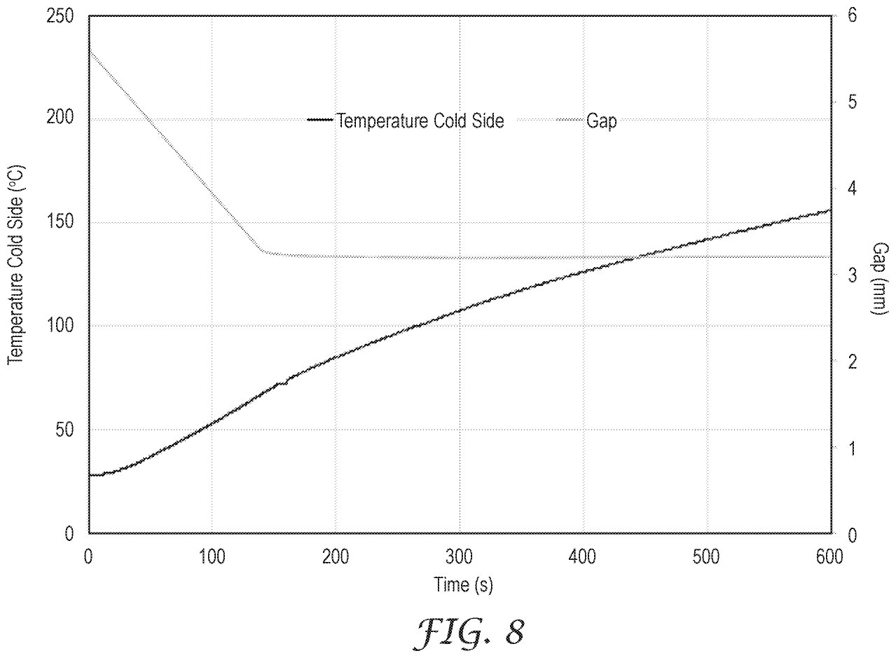

FIG. 8 shows the results of the HCST of Ex 14A (2 layer). The temperature after 10 minutes is 156° C. which is a very promising result compared to other foams tested so far.

### General Hand-Made Preparation Method for the Exemplary Silicone Rubber Foam Layers) and Comparative Examples CE1 And CE2

The A and B parts were weighted in together with the corresponding filler and firming package and mixed by hand. Afterwards they were mixed in a Speedmixer 2500 rpm for 30 seconds two times.

Silicone foam sheets were prepared according to the following procedure: the silicone precursor part A and B of each example were filled in a 200 mL two-part cartridge system from Adchem with a volumetric mixing ratio of 1:1 (200 mL F System cartridge). The two-part silicone system is mixed with a static mixer (MFH 10-18T) using a dispensing gun at 6 bar air pressure. After releasing 70 g of the mixed silicone in a jar, the mixture is additionally homogenized by hand using a wooden spatula for 10 seconds. The mixture is then coated with a knife coater between two PET liner with a defined gap (here 650 μm). The obtained sheet begins to expand at room temperature already, the reaction is completed in a forced air convection oven at 60° C. for 10 minutes.

### Comparative Examples

Commercially available silicone foam formulations Dowsil 3-8235 and Dowsil 3-8209 coated as described herein (CE1 and CE2). Whereas Dowsil 3-8235 Part A and B have very high viscosities (respectively 77000 and 91000 mPa·s) Dowsil 3-8209 has very low viscosity (respectively 15000 and 15000 mPa·s). CE1 resulted in a very homogeneous soft foam as can be seen in table 1 whereas CE2 resulted in an inhomogeneous foam sheet with macroscopic bubble domains. Both CE1 and 2 are very soft what can be seen in the low Compression forces at 40, 50 and 60% of deformation. Although they undergo a ceramization process at elevated temperature they are highly compressed under external stress such as those generated between battery cells. This high compressibility affects the insulation properties under constant pressure as can be seen in the HCST @600° C. under 1 MPa stress. In the case of CE 1, the 150° C. are reached already after 60s when the foam is compressed under 1 MPa (Table 1).

Silicone Foams Filled with ATH and CaCO3

To tune the compression behavior of the silicone foams, firming packages that were added to the low viscosity foam precursors Dowsil 8209. The addition of the firming fillers had the following impact on the foam performance:
Better and uniform foam quality by increasing the viscosity of the foam precursor parts
Better flame resistance
Reduction (absence) of internal stress in the cured foam sheets: e.g. very good dimensional stability.
Better ceramization of the silicone foam (i.e., the conversion of the silicone into a silica based ceramic) at temperatures >250° C.
Tuning of compression characteristics
Prevention of cracks, mechanical integrity of ceramified foam
Reduction of price

When incorporating Aluminum Tri Hydrate (ATH), Calcium Carbonate and optionally Ceramic Fibers the viscosity of the low viscous foam precursors Dowsil 3-8209 could be favorably increased to obtain very homogeneous foam sheets (Ex25 to Ex27). In Examples 26 and 27 (prophetic examples) small amounts of nano TiO2 were further incorporated to increase the thermal resistance of the silicone foam. Incorporating these fillers favorably increase their compression characteristics: the foams became firmer allowing to withstand better external compression stress: under a load of 0.5 MPa the cold side reaches 150° C. only after 385 seconds which is a significant improvement over a very soft foam such as CE1 (Table 6).

TABLE 6
Compositions and properties of silicone foams

| | Example # | CE1 | CE2 | Ex21 | Ex 22 | Ex 23 | Ex 24 | Ex 25 | Ex 26 | Ex 27 |
|---|---|---|---|---|---|---|---|---|---|---|
| A-part | A-Part | 100 | | | | | | | | |
| Composition | Dowsil 3- | | | | | | | | | |
| (in weight | 8235 | | | | | | | | | |
| parts) | A-Part | | 100 | 100 | 100 | 100 | 100 | 100 | 100 | 100 |
| | Dowsil 3- | | | | | | | | | |
| | 8209 | | | | | | | | | |
| | ATH | | | | | | | 56 | 56 | 56 |
| | OL104LEO | | | | | | | | | |
| | Magnifin H-5 | | | 56 | 79 | 56 | | | | |
| | Magnifin H- | | | | | | 56 | | | |
| | 5A (vinyl | | | | | | | | | |
| | surface | | | | | | | | | |
| | modified) | | | | | | | | | |
| | CF50 Fibers | | | 5 | 5 | 5 | 5 | 5 | 5 | 5 |
| B-part | B-Part | 100 | | | | | | | | |
| Composition | Dowsil 3- | | | | | | | | | |
| (in weight | 8235 | | | | | | | | | |
| parts) | B-Part | | 100 | 100 | 100 | 100 | 100 | 100 | 100 | 100 |
| | Dowsil 3- | | | | | | | | | |
| | 8209 | | | | | | | | | |
| | CaCO₃ | | | 67 | 94 | 67 | | 67 | 67 | 67 |
| | Imerseal 74S | | | | | | | | | |
| | Magnifin H- | | | | | | 64 | | | |
| | 5A (vinyl | | | | | | | | | |
| | surface | | | | | | | | | |
| | modified) | | | | | | | | | |
| | Aeroxide | | | | | 5 | | | 5 | 10 |
| | PF2 (TiO2) | | | | | | | | | |
| | Gap (μm) | 350 | 650 | 650 | 650 | 650 | 650 | 650 | 650 | 650 |
| Results | Foam | 2450 | 2510 | 2590 | 2260 | 2260 | 1840 | 3000 | 2440 | 3000 |
| | thickness | | | | | | | | | |
| | (μm) | | | | | | | | | |
| | Coating | 547 | 702 | 1082 | 1148 | 1095 | 1054 | 959 | 1071 | 1060 |
| | weight | | | | | | | | | |
| | (g/m²) | | | | | | | | | |
| | Density | 0.22 | 0.28 | 0.42 | 0.51 | 0.48 | 0.57 | 0.32 | 0.44 | 0.44 |
| | Compression | 35 | 26 | 449 | 836 | 558 | 878 | 340 | 465 | 470 |
| | Force @40% | | | | | | | | | |
| | deformation | | | | | | | | | |
| | (kPa) | | | | | | | | | |
| | Compression | 50 | 40 | 678 | 1345 | 894 | 1475 | 505 | 709 | 713 |
| | Force @50% | | | | | | | | | |
| | deformation | | | | | | | | | |
| | (kPa) | | | | | | | | | |
| | Compression | 83 | 77 | 1267 | >2000 | 1940 | >2000 | 902 | 1321 | 1347 |
| | Force @60% | | | | | | | | | |
| | deformation | | | | | | | | | |
| | (kPa) | | | | | | | | | |
| | HCST of a | 60 | | 387 | 450 | | | | | |
| | stack of 2 | (only | | | | | | | | |
| | layers of | one | | | | | | | | |
| | foam under | layer) | | | | | | | | |
| | 1 MPa, 600° C. | | | | | | | | | |
| | hot side, | | | | | | | | | |
| | time to | | | | | | | | | |
| | reach 150° C. | | | | | | | | | |
| | on the cold | | | | | | | | | |
| | side (in s) | | | | | | | | | |
| | HCST of one | | | | | | | 318 | | |
| | layer under | | | | | | | | | |
| | 0.5 MPa, | | | | | | | | | |
| | 600° C. hot | | | | | | | | | |
| | side, | | | | | | | | | |
| | time to | | | | | | | | | |
| | reach 150° C. | | | | | | | | | |
| | on the cold | | | | | | | | | |
| | side (in s) | | | | | | | | | |

TABLE 6a
HCST Results

| | | | Time to | | | |
|---|---|---|---|---|---|---|
| | | | reach | Cold Side | Gap | Compression |
| | Initial | | 150° C. | Temp | Size | at 600° C. |
| | Gap | | on the | after 10 | after 10 | after |
| | Size | Pressure | cold | minutes | minutes | 10 minutes |
| | (mm) | (MPa) | side (s) | (° C.) | (mm) | (%) |
| 1 Layer | 2.45 | 1 | 60 | 424 | 0.83 | 66 |
| of CE2 | | | | | | |
| 2 Layers | 4.95 | 1 | 196 | 269 | 1.39 | 72 |
| of CE2 | | | | | | |
| 2 Layers | 5.46 | 1 | 385 | 191 | 2.62 | 52 |
| of EX21 | | | | | | |
| 2 Layers | 5.23 | 1 | 450 | 175 | 3.12 | 40 |
| of EX22 | | | | | | |

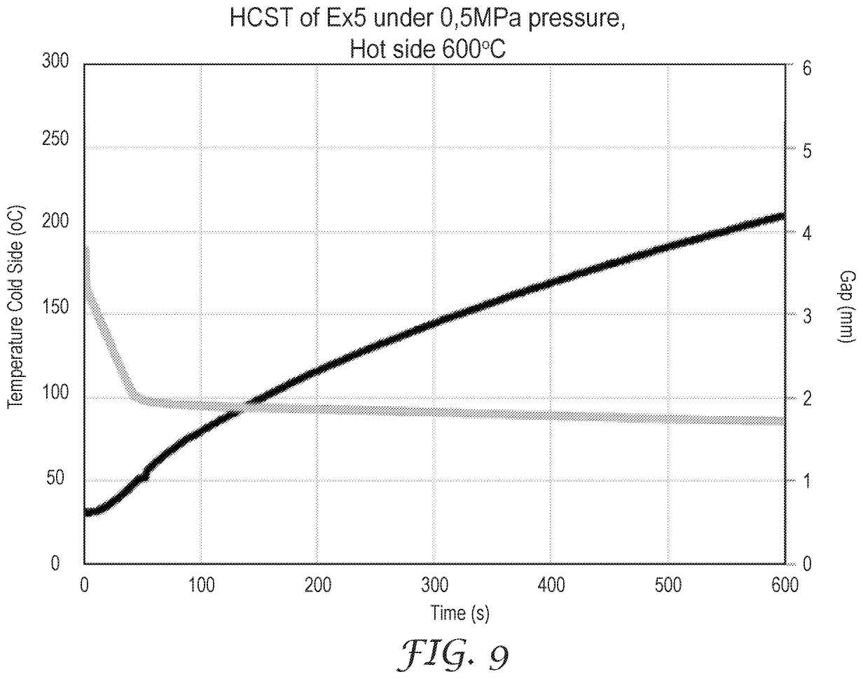

FIG. 9 HCST of a layer of Ex25 under 0.5 MPa pressure, hot side @600° C.

Silicone Foams Filled with Magnesium Hydroxide and CaCO3

Another very favorable flame retardant and smoke suppressant is Magnesium Di Hydrate (MDH). In a 1:1 exchange against ATH (Ex21 vs Ex25) the MDH filled precursors lead to firmer foam constructions at same filler loading. Also, density is higher (0.42 vs 0.32 kg/cm³). Increasing further the filler amount of MDH and CaCO3 results in firmer foam constructions. An advantage of a firmer foam compared to a very soft one (CE1 and 2) is that they are maintaining a higher gap between battery cells at a given compression stress. This higher gap results in better heat insulation properties as can be seen in the HCST of 2 layers of Ex 21 and 22 under a compression force of 1 MPa. In the case of Ex21 the 150° C. are reached only after 387 seconds and for Ex 22 after 531 seconds. Example 24 shows interestingly surface modified MDH results in very a high density foam (0.57 kg/cm³).

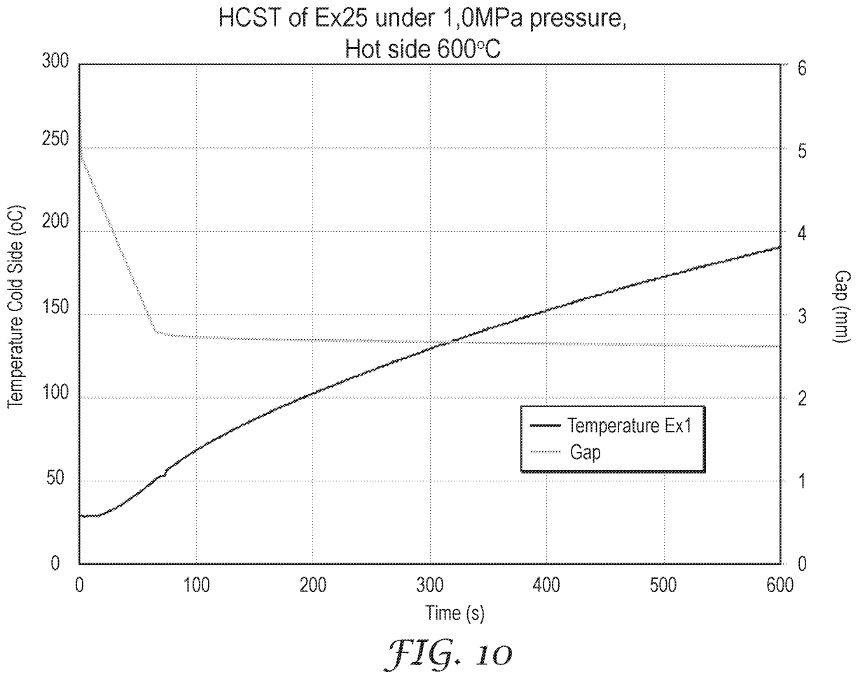

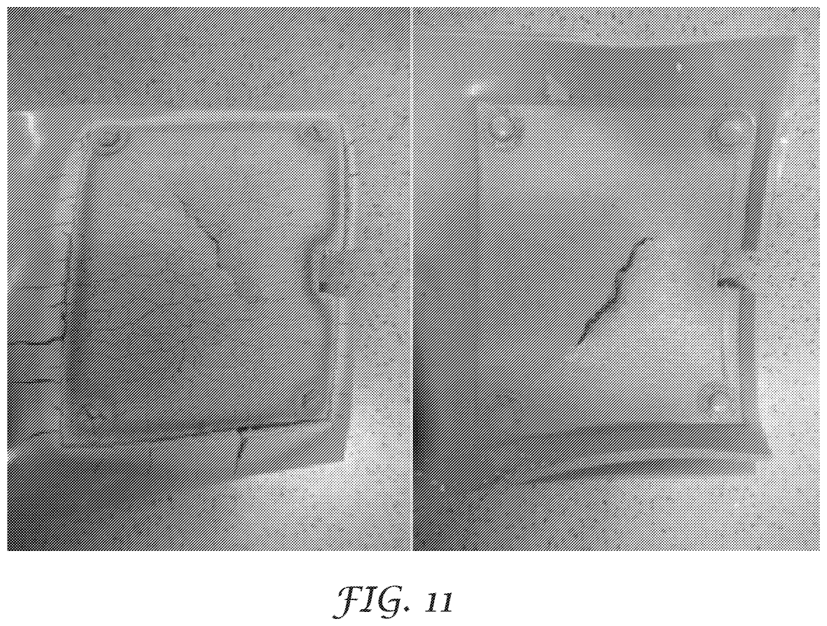

FIG. 10 shows results for HCST of 2 layers of Ex 21 under 1 MPa compression. FIG. 11 shows photographs of the 2 Layers of Ex21 after 17 minutes in contact with the hot plate @600° C. (left: hot side, right: cold side).

From FIG. 11, it can be seen that the hot side started to undergo a ceramization process whereas the cold side is still a silicone rubber foam.

### Thermogravimetric Analysis

The ceramization process has also been analyzed by thermogravimetric analysis (TGA) in N₂ for CE2 (neat silicone foam), Ex 21 filled with MDH and CaCO₃ and Ex25 filled with ATH and CaCO₃.

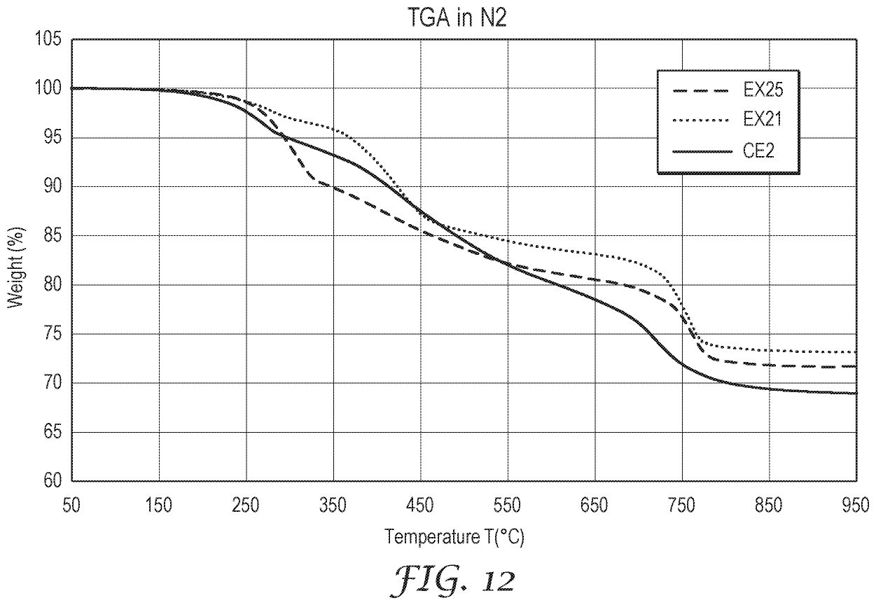

From the TGA Analysis in N₂ shown in FIG. 12, the MDH filled foams start their weight loss later than the ATH filled foams. The weight loss observed at temperatures around 725° C. is related to the thermal oxidation of the calcium carbonate.

The addition of ultrafine MDH or ATH and CaCO₃ to silicone foam precursors can allow for anyone, more or all of the following:
to control the rheology of the foam precursor to obtain optimal foam sheet quality with fine cell distribution and homogeneous thickness.
to tune the compression behavior of the foam sheet by adjusting the filler loading
to make very firm silicone foam sheets with high dimensional stability of the foam sheet (without internal stress)
to effectively retard or prevent thermal propagation when used as cushioning material (e.g., between battery cells) in a battery assembly (e.g., electric vehicle or EV battery assemblies).
to produce silicone foam sheets with exceptional heat insulating properties at very high temperatures (>300° C.)
to effectively reduce the price of expensive silicone materials by blending low cost fillers
when ceramic fibers having short lengths (to provide reinforcement) are added, the crack resistance during the ceramization process at elevated temperatures is greatly improved. Fibers having a length of about 250 to 750 μm (e.g., about 500 μm) can be desirable.

### Additional Disclosure

### Materials

| Designa- | | |
|---|---|---|
| tion | Description | Source |
| CF50 | A mineral fiber with a length of 500 | Lapinus Fibres BV |
| | micrometers and a diameter of 4.5 | (Rockwool BV), |
| | micrometers available under the | Roermond, The |
| | designation CoatForce ® CF50 | Netherlands |
| D3-8209 | 2-part room temperature curable | Dow Chemical |
| | silicone rubber foam formulation | Company, Midland, |
| | commercially available under the | MI. United States |
| | trade designation DOWSIL 3-8209 | |
| D3-8235 | 2-part room temperature curable | Dow Chemical |
| | silicone rubber foam formulation | Company |
| | commercially available under the | |
| | trade designation DOWSIL 3-8235 | |
| EB3242A | Silicone foam available under the | Elkem, Oslo, |
| | trade designation BLUESIL 3242A | Norway |
| IS74S | A surface treated calcium carbonate | Imerys, Paris, |
| | with a d50 of 1.4 micrometers and a | France |
| | low moisture content (<0.08%) | |
| | available under the designation | |
| | IMERSEAL ® 74S | |
| IS75 | Surface modified wet ground marble | Imerys |
| | available under the designation | |
| | IMERSEAL ® 75 | |
| H5 | Magnesium hydroxide (MDH) with a | Huber Martinswerk |
| | d50 of 1.8 micrometers available | GmbH, Bergheim, |
| | under the designation | Germany |
| | MAGNIFIN ® H-5 | |
| H5A | Vinyl surface modified magnesium | Huber Martinswerk |
| | hydroxide (MDH) with a d50 of 1.8 | GmbH |
| | micrometers available under the | |
| | designation MAGNIFIN ® H-5 A | |
| OL104LEO | Aluminum Hydroxide with a d₅₀ | Huber Martinswerk |
| | in a range from 1.7 to 2.1 | GmbH |
| | micrometers, commercially available | |
| | under the trade designation | |
| | MARTINAL OL104LEO | |
| PF2 | Fumed titanium dioxide available | Evonik Industries, |
| | under the designation AEROXIDE ® | Essen, Germany |
| | TiO₂ PF 2 | |
| RN 50/50 | A solid polyethylene terephthalate | Mitsubishi Polyester |
| | (PET) film commercially available | Film, Greer, SC. |
| | under the designation HOSTAPHAN | United States. |
| | RN 50/50 | |
| TS530 | Fumed silica treated with | Cabot, Boston, MA, |
| | hexamethyldisilazane (HMDZ) | United States |
| | available under the designation | |
| | CAB-O-SIL ® TS-530 | |

### Test Methods

### Compression Test

Compression testing was performed using a tensile tester (obtained from ZWICKROELL of Ulm, Germany), in compression mode. The sample had a diameter of 33 mm and a thickness >1000 micrometers. The test was performed at room temperature (typically 23° C.). The upper plate of the compression tester was moved with a speed of 1 mm/min until a maximum force of 2 MPa was reached. The compression force (in kPa) required to reach a compression value of 30%, 40%, 50%, and/or 60% were recorded.

### Hot Side/Cold Side Test (HCST)

In a 10 kN tensile test machine (obtained from ZWICKROELL of Ulm, Germany), a top metal platen (with dimensions of 90×70mm) was heated to 600° C. and a sample was placed on a bottom metal platen with a thermocouple embedded set at 23° C. A heat shield was used to cover the sample to ensure that it stayed at ambient temperature. The heat shield was then removed, and the upper platen was lowered with pressure held at 1 MPa. Time taken to reach 150° C. on the cold side, gap thickness before and after testing, and the temperature of the cold side (C) were recorded.

### Viscosity Test (Flow Curve)

Viscosity testing was performed using a stress-controlled rheometer (Anton Paar, Austria, MCR 302). The samples were measured at room temperature (typically 23° C.) and at a gap of 1 mm with 25 mm diameter parallel plate geometry. After sample pre-conditioning at a constant shear rate of 0.5 s⁻¹ for 30 seconds and a recovery time of 300 seconds, a shear rate ramp was performed from 0.1 s⁻¹ to 100 s⁻¹ (10 points per decade) with measurement time per data point decreasing logarithmically from 15 seconds to 0.5 seconds. The shear rate dependent viscosity values at 0.1 s⁻¹, 1 s⁻¹ and 10 s⁻¹ were exemplarily reported.

### Examples 28-34

Table 7 provides a summary of the foam and filler compositions (in parts by weight) as well as identifies the process used to assemble and the thickness, coating weight, and density of the samples. The samples underwent compression testing, and the results are also represented in Table 7.

TABLE 7
Sample Compositions and Test Results

| | | Ex28 | Ex29 | Ex30 | Ex31 | Ex32 | Ex33 | Ex34 |
|---|---|---|---|---|---|---|---|---|
| Part A | EB3242A | 100 | 100 | 100 | 100 | 100 | 100 | 100 |
| | OL104LEO | 56 | 67 | 56 | 56 | 0 | 33.5 | 28 |
| | H5 | 0 | 0 | 0 | 0 | 56 | 33.5 | 28 |
| | CF50 | 10 | 0 | 10 | 10 | 10 | 0 | 5 |
| | TS530 | 0 | 0 | 0 | 0 | 0 | 0 | 5 |
| Part B | EB3242A | 100 | 100 | 100 | 100 | 100 | 100 | 100 |
| | IS75 | 67 | 60 | 67 | 67 | 67 | 60 | 60 |
| | CF50 | 0 | 10 | 0 | 0 | 0 | 10 | 5 |
| | TS530 | 6.66 | 5 | 0 | 13.32 | 0 | 5 | 5 |
| Gap | Thickness | 400 | 375 | 400 | 400 | 400 | 400 | 400 |
| | (micrometers) | | | | | | | |
| Results | Thickness | 2012 | 2306 | 2690 | 2612 | 3240 | 3441 | 1736 |
| | (micrometers) | | | | | | | |
| | Coating Weight | 966 | 694 | 1049 | 987 | 1085 | 1149 | 809 |
| | (g/m²) | | | | | | | |
| | Density (g/mL) | 0.48 | 0.301 | 0.39 | 0.378 | 0.335 | 0.334 | 0.466 |
| Compression | 40% (kPa) | 413 | 103 | 239 | 353 | 238 | 251 | 520 |
| Testing | 50% (kPa) | 537 | 140 | 320 | 437 | 307 | 327 | 641 |
| | 60% (kPa) | 731 | 202 | 462 | 577 | 407 | 496 | 829 |

TABLE 8
Sample Compositions and Viscosity Test Results

| | | CE1 | CE1 | Ex19 | Ex19 |
|---|---|---|---|---|---|
| | | Part A | Part B | Part A | Part B |
| | D3-8209 | 100 | 0 | 100 | 0 |
| | OL104LEO | 0 | 0 | 101 | 0 |
| | CF50 | 0 | 0 | 17.5 | 0 |
| | D3-8209 | 0 | 100 | 0 | 100 |
| | IS74S | 0 | 0 | 0 | 116 |
| Results | Viscosity at 23° C., | 15.60 | 17.26 | 1382.35 | 581.79 |
| | 0.1 s⁻¹ | | | | |
| | (Pa*s) | | | | |
| | Viscosity at 23° C., | 14.67 | 16.97 | 409.95 | 166.19 |
| | 1 s⁻¹ | | | | |
| | (Pa*s) | | | | |
| | Viscosity at 23° C., | 14.10 | 16.88 | 157.30 | 83.89 |
| | 10 s⁻¹ | | | | |
| | (Pa*s) | | | | |

1. A thermal insulation/protection barrier operatively adapted for being disposed between adjacent battery cells of a battery pack or module, with the thermal insulation/protection barrier comprising a cured silicone rubber non-syntactic foam layer having at least one major surface, and at least one optional solid film, wherein the solid film is disposed so as to cover the at least one major surface of the silicone rubber foam layer, and the silicone rubber foam layer comprises a plurality of firming particles disposed within the silicone rubber foam layer in an amount sufficient to impart additional firmness to the silicone rubber foam layer so that it takes a greater compressive force to compress the foam layer to a desired compression value, compared to the same silicone rubber foam layer without the firming particles.

2. The thermal insulation/protection barrier according to claim 1, wherein the silicone rubber foam layer is formed from a curable and foamable precursor of silicone rubber foam comprising:
at least one organopolysiloxane compound A;
at least one organohydrogenpolysiloxane compound B comprising at least two or three hydrogen atoms per molecule;
at least one hydroxyl containing compound C; and
an effective amount of a curing catalyst D.

3. The thermal insulation/protection barrier according to claim 1, wherein the plurality of firming particles are disposed uniformly throughout said silicone rubber foam layer.

4. The thermal insulation/protection barrier according to claim 1, wherein the plurality of firming particles are in an amount sufficient to cause the silicone rubber foam layer to exhibit a compression value of no more than about 50%, when subjected to a compression force of at least 100 kPa.

5. The thermal insulation/protection barrier according to claim 1, wherein the plurality of firming particles are in an amount sufficient to cause the silicone rubber foam layer to exhibit a compression value of no more than 30%, when subjected to a compression force of at least 100 kPa.

6. The thermal insulation/protection barrier according to claim 1, wherein the amount of firming particles is in the range of from about 10 weight % up to and including about 60 weight %, or in the range of from about 5 volume % up to and including about 30 volume %.

7. The thermal insulation/protection barrier according to claim 1, wherein the amount of firming particles is about 40 weight %, or about 20 volume %.

8. The thermal insulation/protection barrier according to claim 1, wherein the firming particles are any one or combination of the material particles selected from aluminum trihydroxide (ATH) particles, magnesium hydroxide (MDH) particles, calcium carbonate particles, titanium oxide particles, silicon oxide particles and mineral fibers.

9. The thermal insulation/protection barrier according to claim 1, wherein the firming particles have a size in the range of from at least about 0.5 μm up to and including about 10 μm.

10. The thermal insulation/protection barrier according to claim 1, wherein the firming particles have a size of about 2 μm.

11. The thermal insulation/protection barrier according to claim 1, wherein the firming particles include non metallic inorganic fibers (e.g., mineral fibers) have length in the range of from at least about 200 μm up to and including about 1000 μm.

12. The thermal insulation/protection barrier according to claim 1, wherein the amount of firming particles is sufficient to cause the silicone rubber foam layer to exhibit a compression value of no more than about 60% when subjected to a compression force of over 1200 kPa.

13. The thermal insulation/protection barrier according to claim 1, wherein the silicone rubber foam layer exhibits a compression value of no more than about 50% when subjected to a compression force of at least 200 kPa.

14. The thermal insulation/protection barrier according to claim 1, wherein the silicone rubber foam layer exhibits a compression value of no more than about 50% when subjected to a compression force of over 1200 kPa.

15. The thermal insulation/protection barrier according to claim 1, wherein the silicone rubber foam layer exhibits a compression value of no more than about 30% when subjected to a compression force of over 200 kPa.

16. The thermal insulation/protection barrier according to claim 1, wherein the silicone rubber foam layer exhibits a compression value of no more than about 30% when subjected to a compression force of over 400 kPa.

17. The thermal insulation/protection barrier according to claim 1, wherein the silicone rubber foam layer exhibits a compression value of in the range of from about 30% up to a maximum of about 50%, when subjected to a compression force in the range of from about 200 kPa up to no greater than about 1000 kPa.

18. The thermal insulation/protection barrier according to claim 1, wherein the silicone rubber foam layer exhibits a compression value of in the range of from about 30% up to a maximum of about 50%, when a compression force in the range of from about 300 kPa up to no greater than about 800 kPa.

19. The thermal insulation/protection barrier according to claim 1, wherein the firming particles, individually or together, exhibit any one or combination of the properties selected from silicone foam precursor viscosity increaser or thickener, foam matrix reinforcement, being relatively low cost, endothermic, a fire retardant, and structural reinforcement to the foam matrix.

20. A battery assembly comprising the thermal insulation/protection barrier according to claim 1.
